(19) United States
(12) Patent Application Publication
(10) Pub. No.: US 2013/0070440 A1
(43) Pub. Date: Mar. 21, 2013

(54) OLED Light Panel in Combination with a Gobo

(71) Applicants: Peter Levermore, Lambertville, NJ (US); Emory Krall, Philadelphia, PA (US)

(72) Inventors: Peter Levermore, Lambertville, NJ (US); Emory Krall, Philadelphia, PA (US)

(73) Assignee: Universal Display Corporation, Ewing, NJ (US)

(21) Appl. No.: 13/239,134

(22) Filed: Sep. 21, 2011

(51) Int. Cl. F21V 9/00; F21K 2/00

(52) U.S. Cl. 362/84; 362/293; 362/255

(57) ABSTRACT

A first device is provided. The first device may include a first light source comprising one or more organic light emitting devices and a gobo that is optically coupled to the first light source. The gobo may allow differential transmission of light emitted by different parts of the first light source so as to create a fixed variation in the light emitted by the first device.

### BACKGROUND OF THE INVENTION

Opto-electronic devices that make use of organic materials are becoming increasingly desirable for a number of reasons. Many of the materials used to make such devices are relatively inexpensive, so organic opto-electronic devices have the potential for cost advantages over inorganic devices. In addition, the inherent properties of organic materials, such as their flexibility, may make them well suited for particular applications such as fabrication on a flexible substrate. Examples of organic opto-electronic devices include organic light emitting devices (OLEDs), organic phototransistors, organic photovoltaic cells, and organic photodetectors. For OLEDs, the organic materials may have performance advantages over conventional materials. For example, the wavelength at which an organic emissive layer emits light may generally be readily tuned with appropriate dopants.

OLEDs make use of thin organic films that emit light when voltage is applied across the device. OLEDs are becoming an increasingly interesting technology for use in applications such as flat panel displays, illumination, and backlighting. Several OLED materials and configurations are described in U.S. Pat. Nos. 5,844,363, 6,303,238, and 5,707,745, which are incorporated herein by reference in their entirety.

One application for phosphorescent emissive molecules is a full color display. Industry standards for such a display call for pixels adapted to emit particular colors, referred to as “saturated” colors. In particular, these standards call for saturated red, green, and blue pixels. Color may be measured using CIE coordinates, which are well known to the art.

One example of a green emissive molecule is tris (2-phenylpyridine) iridium, denoted Ir(ppy)₃, which has the structure of Formula I:

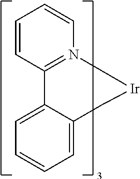

In this, and later figures herein, we depict the dative bond from nitrogen to metal (here, Ir) as a straight line.

As used herein, the term “organic” includes polymeric materials as well as small molecule organic materials that may be used to fabricate organic opto-electronic devices. “Small molecule” refers to any organic material that is not a polymer, and “small molecules” may actually be quite large. Small molecules may include repeat units in some circumstances. For example, using a long chain alkyl group as a substituent does not remove a molecule from the “small molecule” class. Small molecules may also be incorporated into polymers, for example as a pendent group on a polymer backbone or as a part of the backbone. Small molecules may also serve as the core moiety of a dendrimer, which consists of a series of chemical shells built on the core moiety. The core moiety of a dendrimer may be a fluorescent or phosphorescent small molecule emitter. A dendrimer may be a “small molecule,” and it is believed that all dendrimers currently used in the field of OLEDs are small molecules.

As used herein, “top” means furthest away from the substrate, while “bottom” means closest to the substrate. Where a first layer is described as “disposed over” a second layer, the first layer is disposed further away from substrate. There may be other layers between the first and second layer, unless it is specified that the first layer is “in contact with” the second layer. For example, a cathode may be described as “disposed over” an anode, even though there are various organic layers in between.

As used herein, “solution processible” means capable of being dissolved, dispersed, or transported in and/or deposited from a liquid medium, either in solution or suspension form.

A ligand may be referred to as “photoactive” when it is believed that the ligand directly contributes to the photoactive properties of an emissive material. A ligand may be referred to as “ancillary” when it is believed that the ligand does not contribute to the photoactive properties of an emissive material, although an ancillary ligand may alter the properties of a photoactive ligand.

As used herein, and as would be generally understood by one skilled in the art, a first “Highest Occupied Molecular Orbital” (HOMO) or “Lowest Unoccupied Molecular Orbital” (LUMO) energy level is “greater than” or “higher than” a second HOMO or LUMO energy level if the first energy level is closer to the vacuum energy level. Since ionization potentials (IP) are measured as a negative energy relative to a vacuum level, a higher HOMO energy level corresponds to an IP having a smaller absolute value (an IP that is less negative). Similarly, a higher LUMO energy level corresponds to an electron affinity (EA) having a smaller absolute value (an EA that is less negative). On a conventional energy level diagram, with the vacuum level at the top, the LUMO energy level of a material is higher than the HOMO energy level of the same material. A “higher” HOMO or LUMO energy level appears closer to the top of such a diagram than a “lower” HOMO or LUMO energy level.

As used herein, and as would be generally understood by one skilled in the art, a first work function is “greater than” or “higher than” a second work function if the first work function has a higher absolute value. Because work functions are generally measured as negative numbers relative to vacuum level, this means that a “higher” work function is more negative. On a conventional energy level diagram, with the vacuum level at the top, a “higher” work function is illustrated as further away from the vacuum level in the downward direction. Thus, the definitions of HOMO and LUMO energy levels follow a different convention than work functions.

More details on OLEDs, and the definitions described above, can be found in US Pat. No. 7,279,704, which is incorporated herein by reference in its entirety.

### BRIEF SUMMARY OF THE INVENTION

Embodiments provided herein may comprise a gobo in combination with one or more organic light emitting devices. In this regard, a first device may be provided. The first device may include a first light source comprising one or more organic light emitting devices and a gobo that is optically coupled to the first light source. The gobo may allow differential transmission of light emitted by different parts of the first light source so as to create a fixed variation in the light emitted by the first device.

In some embodiments, in the first device as described above, the first light source comprises a plurality of organic light emitting devices that are commonly addressable. In some embodiments, in the first device as described above, all of the organic light emitting devices that are optically coupled to the gobo are commonly addressable. In some embodiments, in the first device as described above, all of the organic light emitting devices disposed on the first device are commonly addressable.

In some embodiments, in the first device as described above comprising a first light source optically coupled to a gobo, the first light source emits light that has a Duv value that is less than 0.010. In some embodiments, in the first device as described above, the first light source is color tunable.

In some embodiments, in the first device as descried above where the first light source emits white light having a Duv that is less than 0.010, the first light source may also be color tunable between a correlated color temperature (CCT) of approximately 2800 K to 9000 K. Preferably, the first light source may be color tunable between a correlated color temperature (CCT) of approximately 3500 K to 6500 K.

In some embodiments, in the first device as described above comprising a first light source optically coupled to a gobo, the first light source is dimmable. In some embodiments, in the first device as described above, the first light source may be locally dimmable.

In some embodiments, in the first device as described above comprising a first light source optically coupled to a gobo, the first light source may comprise a light emitting zone and a first distance between a portion of the light emitting zone of the first light source and a portion of the gobo may be less than 1 cm. In some embodiments, in the first device as described above, the maximum distance between a portion of the light emitting zone of the first light source and a portion of the gobo may be less than 1 cm. In some embodiments, where the maximum distance between a portion of the light emitting zone of the first light source and a portion of the gobo is less than 1 cm, substantially all of the gobo is optically coupled to the first light source.

In some embodiments, in the first device as described above comprising a first light source optically coupled to a gobo and where the first light source comprises a light emitting zone, a first distance between a portion of the light emitting zone of the first light source and a portion of the gobo may be less than 3 mm. In some embodiments, in the first device as described above, the maximum distance between a portion of the light emitting zone of the first light source and a portion of the gobo is less than 3 mm. In some embodiments, in the first device as described above where the maximum distance between a portion of the light emitting zone of the first light source and a portion of the gobo is less than 3 mm, substantially all of the gobo may be optically coupled to the first light source.

In some embodiments, in the first device as described above comprising a first light source optically coupled to a gobo, a surface of the first light source and the gobo are in physical contact. In some embodiments, a surface of the first light source and the gobo are in physical contact across the entire emissive area of the first light source. In some embodiments, the portions of the gobo that are optically coupled to the first light source are in physical contact with a surface of the first light source.

In some embodiments, in the first device as described above comprising a first light source optically coupled to a gobo, at least a portion of the gobo is not in physical contact with a surface of the first light source. In some embodiments where the first light source comprises a light emitting zone, the maximum distance between a portion of the light emitting zone of the first light source and a portion of the gobo is less than 1 cm and the minimum distance between a portion of the light emitting zone of the first light source and a portion of the gobo is greater than 0.1 mm. In some embodiments, the maximum distance between a portion of the light emitting zone of the first light source and a portion of the gobo is less than 1 mm.

In some embodiments, in the first device as described above comprising a first light source optically coupled to a gobo, the first device may not comprise a cooling element disposed between the first light source and the gobo. In some embodiments, in the first device as described above, the first light source may include a substrate and the first device may not comprise a cooling element disposed between the substrate of the first light source and the gobo.

In some embodiments, in the first device as described above comprising a first light source optically coupled to a gobo, the gobo is disposed relative to the first light source such that the temperature of the gobo does not exceed 50° C. when the first device is in operation.

In some embodiments, in the first device as described above comprising a first light source optically coupled to a gobo, the gobo is disposed relative to the first light source such that there is no part of the gobo that has a temperature that is more than 50° C. greater than ambient temperature when the first device is in operation. In some embodiments, the gobo may be disposed relative to the first light source such that there is no part of the gobo that has a temperature that is more than 30° C. greater than ambient temperature when the first device is in operation. In some embodiments, the gobo may be disposed relative to the first light source such that there is no part of the gobo that has a temperature that is more than 20° C. greater than ambient temperature when the first device is in operation.

In some embodiments, in the first device as described above where the gobo is disposed relative to the first light source such that there is no part of the gobo that has a temperature that is more than 50° C. greater than ambient temperature when the first device is in operation and where the first light source comprises a light emitting zone, a first distance between a portion of the light emitting zone of the first light source and a portion of the gobo may be less than 1 cm. In some embodiments, the maximum distance between a portion of the light emitting zone of the first light source and a portion of the gobo may be less than 3 mm. In some embodiments, a surface of the first light source and the gobo may be in physical contact.

In some embodiments, in the first device as described above comprising a first light source optically coupled to a gobo, light having a peak wavelength between 400 nm and 750 nm emitted from the first light source does not propagate through a first portion of the gobo. In some embodiments, the first portion may comprise at least 10% of the gobo.

In some embodiments, in the first device as described above comprising a first light source optically coupled to a gobo, the gobo may comprise an opaque structure that completely blocks visible light from a first portion of the light source while allowing transmission of visible light from a second portion of the light source.

In some embodiments, in the first device as described above comprising a first light source optically coupled to a gobo, the first light source may include a substrate. Each of the organic light emitting devices of the first light source may include a first electrode disposed over the substrate, a second electrode disposed over the first electrode, and an organic electroluminescent (EL) material disposed between the first and the second electrode.

In some embodiments, in the first device as described above where the first light source comprises a substrate, a first and second electrode, and an organic EL material disposed between the electrodes, the substrate may be rigid or it may be flexible. In some embodiments, where the substrate is rigid, the gobo may be flexible. The first light source may include an emissive area and the gobo may be configured to be selectively disposed so as to be optically coupled to at least a portion of the emissive area of the first light source. In some embodiments, where the substrate is flexible, the gobo (or a portion thereof) may also be flexible. In some embodiments, where the substrate and/or the gobo is flexible, the flexible component may comprise a material having a Young's modulus that is less than approximately 10 GPa.

In some embodiments, in first device as described above where the gobo comprises a flexible material, at least a portion of the gobo conforms to at least a portion of the substrate. In some embodiments, where the gobo comprises a flexible material, at least a portion of the gobo substantially conforms to at least a portion of the substrate. In some embodiments, where the gobo comprises a flexible material, the entire gobo substantially conforms to at least a portion of the substrate. In some embodiments, where the gobo comprise a flexible material, the first light source may comprise an emissive area, and the entire gobo may substantially conform to a portion of the substrate that is disposed over the emissive area.

In some embodiments, in the first device as described above where the gobo comprises a flexible material, the substrate may also comprise a flexible material and may be movably flexible between a first position and a second position. At least a portion of the gobo may substantially conform to at least a portion of the substrate in both the first position and the second position. In some embodiments, the entire gobo substantially conforms to at least a portion of the substrate in both the first position and the second position.

In some embodiments, in the first device as described above, the substrate is flexible and the gobo is rigid. In some embodiments, the substrate is rigid and the gobo is flexible. In some embodiments, both the gobo and the substrate are flexible.

In some embodiments, in the first device as described above comprising a first light source optically coupled to a gobo, the gobo may comprise a flexible material and may be laminated to the first light source. In some embodiments, the gobo may be laminated to the first light source using an adhesive. In some embodiments, the gobo may be directly coupled to the first light source using an adhesive. In some embodiments, the gobo is removably coupled to the first light source using an adhesive. In some embodiments, the adhesive may be transparent or semi-transparent.

In some embodiments, in the first device as described above comprising a first light source optically coupled to a gobo, the gobo and the first light source have a combined thickness that is less than approximately 5 cm. In some embodiments, the gobo and the first light source have a combined thickness that is less than approximately 1 cm. In some embodiments, the gobo and the first light source have a combined thickness that is less than approximately 1 mm. In some embodiments, the gobo and the first light source have a combined thickness that is less than approximately 0.5 mm.

In some embodiments, in the first device as described above where the gobo has a temperature that is no more than 50° C. greater than ambient temperature when the first device is in operation, the first light source has a luminance of at least 1000 cd/m². In some embodiments, the first light source has a luminance of at least 3000 cd/m². In some embodiments, the first light source has a luminance of at least 5000 cd/m². In some embodiments, where the first light source has a luminance of at least 1000 cd/m², the gobo is disposed relative to the first light source such that there is no part of the gobo that has a temperature that is more than 50° C. greater than ambient temperature when the first device is in operation. In some embodiments, where the first light source has a luminance of at least 1000 cd/m², the gobo is disposed relative to the first light source such that there is no part of the gobo that has a temperature that is more than 30° C. greater than ambient temperature when the first device is in operation. In some embodiments, where the first light source has a luminance of at least 1000 cd/m², the gobo is disposed relative to the first light source such that there is no part of the gobo that has a temperature that is more than 20° C. greater than ambient temperature when the first device is in operation.

In some embodiments, in the first device as described above comprising a first light source optically coupled to a gobo, the gobo comprises a material that is not stable at temperatures that are greater than 150° C. In some embodiments the gobo comprises a material that is not stable at temperatures that are greater than 100° C. In some embodiments, the gobo comprises a material that is not stable at temperatures that are greater than 70° C.

In some embodiments, in the first device as described above comprising a first light source optically coupled to a gobo, the first device further includes a support structure. The first light source and the gobo may be coupled to the support structure, where at least one of the first light source or the gobo is removably coupled to the support structure. In some embodiments, where the gobo is removably coupled to the support structure, the gobo may be adapted to be removed and recoupled to the support structure. In some embodiments, the support structure comprises a conductive path to the first light source. In some embodiments, the support structure comprises a light fixture.

In some embodiments, in the first device as described above comprising a first light source optically coupled to a gobo, the gobo may comprise a transparent or translucent plastic. In some embodiments, the gobo has a thickness that is less than approximately 1 cm. In some embodiments, the gobo may have a thickness that is less than approximately 1 mm. In some embodiments, the gobo may have a thickness that is less than approximately 0.5 mm.

In some embodiments, in the first device as described above where the gobo comprises a transparent or translucent plastic material, the gobo comprises at least one of: Polyethylene Naphthalate [PEN] (Tg=120° C.); Polyethylene [PET] (Tg=70° C.); Poly(methyl methacrylate)

[PMMA] (Tg=105° C.); Poly(vinyl chloride) [PVC] (Tg=80° C.); Polystyrene [PS] (Tg=95° C.); Polylactic acid [PLA] (Tg>60-65° C.); Polypropylene [PP] (Tg=0° C., Tm>130° C.); or Polycarbonate [PC] (Tg=145° C.).

In some embodiments, in the first device as described above comprising a first light source optically coupled to a gobo, the first light source has an area that is greater than 10 cm².

In some embodiments, the first light source has an area that is greater than 25 cm². In some embodiments, the first light source has an area that is between approximately 20 cm² and 10 m².

In some embodiments, in the first device as described above comprising a gobo optically coupled to a first light source, the first light source may include a plurality of substrates. In some embodiments, a plurality of OLEDs may be disposed on one or more of the plurality of substrates. In some embodiments, the first device may include a plurality of OLEDs optically coupled to a single gobo. In some embodiments, one OLED of the first light source may be optically coupled to a plurality of gobos. In some embodiments, a plurality of OLEDs of the first light source may be optically coupled to a plurality of gobos.

In some embodiments, in the first device as described above comprising a first light source optically coupled to a gobo, the first device further comprises a light scattering layer disposed between the first light source and the gobo. In some embodiments, in the first device as described above, the first light source comprises at least 50% luminance uniformity. In some embodiments, the first light source comprises at least 80% luminance uniformity. In some embodiments, in the first device as described above, the first light source has a color uniformity that has a duv that is less than 0.010.

In some embodiments, in the first device as described above comprising a first light source optically coupled to a gobo, the first light source comprises a single organic light emitting device. In some embodiments, in the first device as described above, the first light source comprises a plurality of organic light emitting devices. In some embodiments, in the first device as described above, the first light source comprises a lighting panel.

In some embodiments, in the first device as described above comprising a first light source optically coupled to a gobo, the gobo comprises a stencil. In some embodiments, where the gobo comprises a stencil, the gobo comprises at least one of a plastic or glass material. In some embodiments, where the gobo comprises a stencil, the gobo is patterned.

In some embodiments, in the first device as described above comprising a first light source optically coupled to a gobo, the gobo may further include a first portion having a first light transmission level, a second portion having a second transmission level, and a third portion having a third transmission level. The first, second, and third transmission levels may be different.

In some embodiments, in the first device as described above comprising a first light source optically coupled to a gobo, the gobo may comprise a color filter. In some embodiments, the gobo is a sheet of plastic having an image rendered thereon by one or more gels that preferentially transmit a portion of the visible spectrum. In some embodiments, the gobo includes at least two different gels having different transmittance properties. In some embodiments, the gobo comprises a first gel and a second gel, where the first and second gel preferentially transmit light having different peak wavelengths. In some embodiments, the gobo includes at least three different gels having different transmittance properties. In some embodiments, in the first device as described above, the gobo includes at least one down conversion material.

A first device may also be provided that comprises a first support structure configured to hold a first light source comprising one or more organic light emitting devices and a second support structure configured to hold a gobo.

In some embodiments, in the first device as described above that includes a first and a second support structure, the first and/or the second support structure comprises a recess for receiving either the first light source or the gobo. In some embodiments, in the first device as described above that includes a first and a second support structure, the second support structure is configured to hold a gobo that is removably coupled to the support structure.

In some embodiments, in the first device as described above that includes a first and a second support structure and where the first light source comprises a light emitting zone, the first and second support structures are disposed such that a portion of the light emitting zone of the first light source and a portion of the gobo are separated by less than approximately 1 cm. In some embodiments, the first and second support structures are disposed such that a portion of the light emitting zone of the first light source and a portion of the gobo are separated by less than approximately 1 mm. In some embodiments, the first and second support structures are disposed such that a portion of the light emitting zone of the first light source and a portion of the gobo are separated by less than approximately 0.5 mm.

A first method of creating an image is also provided. The first method may comprise optically coupling a gobo to a first light source that includes one or more organic light emitting devices. In some embodiments, the first method may further include the step of attaching the gobo to the first light source.

Embodiments may provide a device that includes a light source comprising one or more OLEDs that are optically coupled to a gobo. The gobo may alter the light emitted by the first light source in a manner that is perceivable by a viewer such that an image or a pattern may be observed (e.g. by directly observing the device or by indirectly viewing the light transmitted through the gobo on another surface). In this manner, embodiments may provide a less expensive, less complex, adaptable, and/or robust manner of displaying images (such as billboards, advertisements, decorations, etc.), grayscaling images, providing visual patterns, etc. in comparison to more complex devices such as, for instance, a panel display. In addition, the use of an OLED in embodiments may, in some instances, provide advantages in comparison to devices that use other light sources, such as incandescent lamps or LEDs. In this regard, the inventors have found that typical OLED properties such as, for instance, low operating temperatures; thinner form factors; higher brightness levels for lower power consumption;

flexible materials; etc. may provide advantages and enable configurations of devices that comprise a gobo not necessarily found in devices that use other light sources.

### BRIEF DESCRIPTION OF THE DRAWINGS

FIG. 1 shows an organic light emitting device.

FIG. 2 shows an inverted organic light emitting device that does not have a separate electron transport layer.

FIG. 3 shows an example of a device that comprises a light source and a diffuser.

FIG. 4 shows an example of a device comprising a gobo and an incandescent light source.

FIG. 5 is a photograph of an example of a device comprising a gobo and an incandescent light source.

FIG. 6 is a photograph of an example of a gobo comprising an image in accordance with some embodiments.

FIG. 7 shows a panel layout of an exemplary OLED lighting device in accordance with some embodiments.

FIG. 8 shows a close up view of a panel layout of an exemplary OLED lighting device in accordance with some embodiments.

FIG. 9 is a photograph of an experimental OLED lighting device fabricated in accordance with some embodiments.

FIG. 10 shows an emissive spectrum of an exemplary OLED lighting device in accordance with some embodiments.

FIG. 11 shows example locations on an exemplary OLED light device for measuring luminance and chromaticity.

FIGS. 12(a)-(d) show two exemplary gobos in accordance with some embodiments.

FIG. 13 shows an exemplary gobo comprising a color image in accordance with some embodiments.

FIG. 14 shows an exemplary chromaticity diagram of the light emissions through point on a gobo in accordance with some embodiments.

FIGS. 15(a)-(c) show examples of transmission spectra for conventional color filters from the Rosco Roscolux range. FIG. 15(a) corresponds to #24 Scarlet; FIG. 15(b) corresponds to #389 Chroma Green; and FIG. 15(c) corresponds to #79 Bright Blue.

FIGS. 16(a)-(c) show examples of transmission spectra for dichroic color filters from the Rosco Permacolor range. FIG. 15(a) corresponds to #6500 Primary Red; FIG. 15(b) corresponds to #5055 Primary Green; and Fig. (c) corresponds to #1080 Primary Blue.

FIG. 17 shows an exemplary device comprising an example of a gobo in accordance with some embodiments.

FIG. 18(a) shows an exemplary device comprising an example of a gobo in accordance with some embodiments. FIG. 18(b) shows a close-up of a portion of the exemplary device in FIG. 18(a).

FIG. 19(a) shows an exemplary OLED light panel in accordance with some embodiments in an unflexed state. FIG. 19(b) shows the exemplary OLED light panel shown in

FIG. 19(a) in a flexed state. FIG. 19(c) shows the exemplary OLED light panel shown in FIG. 19(a) in optical communication with an exemplary gobo in accordance with some embodiments. FIG. 19(d) shows the exemplary OLED light panel and the exemplary gobo shown in FIG. 19(c) in a flexed position.

### DETAILED DESCRIPTION OF THE INVENTION

Generally, an OLED comprises at least one organic layer disposed between and electrically connected to an anode and a cathode. When a current is applied, the anode injects holes and the cathode injects electrons into the organic layer(s). The injected holes and electrons each migrate toward the oppositely charged electrode. When an electron and hole localize on the same molecule, an “exciton,” which is a localized electron-hole pair having an excited energy state, is formed. Light is emitted when the exciton relaxes via a photoemissive mechanism. In some cases, the exciton may be localized on an excimer or an exciplex. Non-radiative mechanisms, such as thermal relaxation, may also occur, but are generally considered undesirable.

The initial OLEDs used emissive molecules that emitted light from their singlet states (“fluorescence”) as disclosed, for example, in U.S. Pat. No. 4,769,292, which is incorporated by reference in its entirety. Fluorescent emission generally occurs in a time frame of less than 10 nanoseconds.

More recently, OLEDs having emissive materials that emit light from triplet states (“phosphorescence”) have been demonstrated. Baldo et al., “Highly Efficient Phosphorescent Emission from Organic Electroluminescent Devices,” Nature, vol. 395, 151-154, 1998; (“Baldo-I”) and Baldo et al., “Very high-efficiency green organic light-emitting devices based on electrophosphorescence,” Appl. Phys. Lett., vol. 75, No. 3, 4-6 (1999) (“Baldo-II”), which are incorporated by reference in their entireties. Phosphorescence is described in more detail in U.S. Pat. No. 7,279,704 at cols. 5-6, which are incorporated by reference.

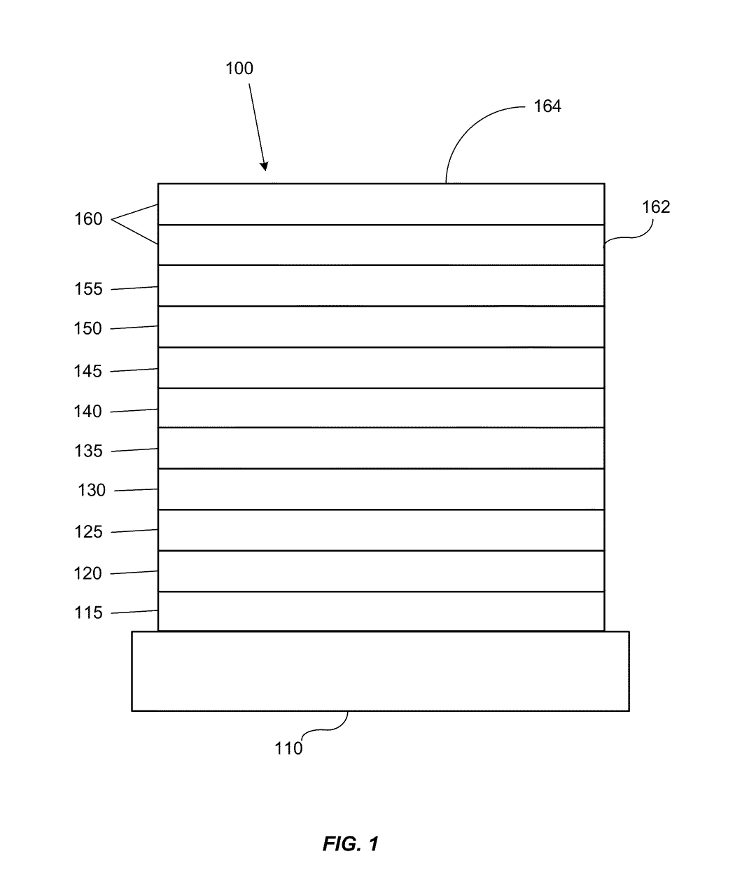

FIG. 1 shows an organic light emitting device 100. The figures are not necessarily drawn to scale. Device 100 may include a substrate 110, an anode 115, a hole injection layer 120, a hole transport layer 125, an electron blocking layer 130, an emissive layer 135, a hole blocking layer 140, an electron transport layer 145, an electron injection layer 150, a protective layer 155, and a cathode 160. Cathode 160 is a compound cathode having a first conductive layer 162 and a second conductive layer 164. Device 100 may be fabricated by depositing the layers described, in order. The properties and functions of these various layers, as well as example materials, are described in more detail in U.S. Pat. No. 7,279,704 at cols. 6-10, which are incorporated by reference.

More examples for each of these layers are available. For example, a flexible and transparent substrate-anode combination is disclosed in U.S. Pat. No. 5,844,363, which is incorporated by reference in its entirety. An example of a p-doped hole transport layer is m-MTDATA doped with F.sub.4-TCNQ at a molar ratio of 50:1, as disclosed in U.S. Patent Application Publication No. 2003/0230980, which is incorporated by reference in its entirety. Examples of emissive and host materials are disclosed in U.S. Pat. No. 6,303,238 to Thompson et al., which is incorporated by reference in its entirety. An example of an n-doped electron transport layer is BPhen doped with Li at a molar ratio of 1:1, as disclosed in U.S. Patent Application Publication No. 2003/0230980, which is incorporated by reference in its entirety. U.S. Pat. Nos. 5,703,436 and 5,707,745, which are incorporated by reference in their entireties, disclose examples of cathodes including compound cathodes having a thin layer of metal such as

Mg:Ag with an overlying transparent, electrically-conductive, sputter-deposited ITO layer. The theory and use of blocking layers is described in more detail in U.S. Pat. No. 6,097,147 and U.S. Patent Application Publication No. 2003/0230980, which are incorporated by reference in their entireties. Examples of injection layers are provided in U.S. Patent Application Publication No. 2004/0174116, which is incorporated by reference in its entirety. A description of protective layers may be found in U.S. Patent Application Publication No. 2004/0174116, which is incorporated by reference in its entirety.

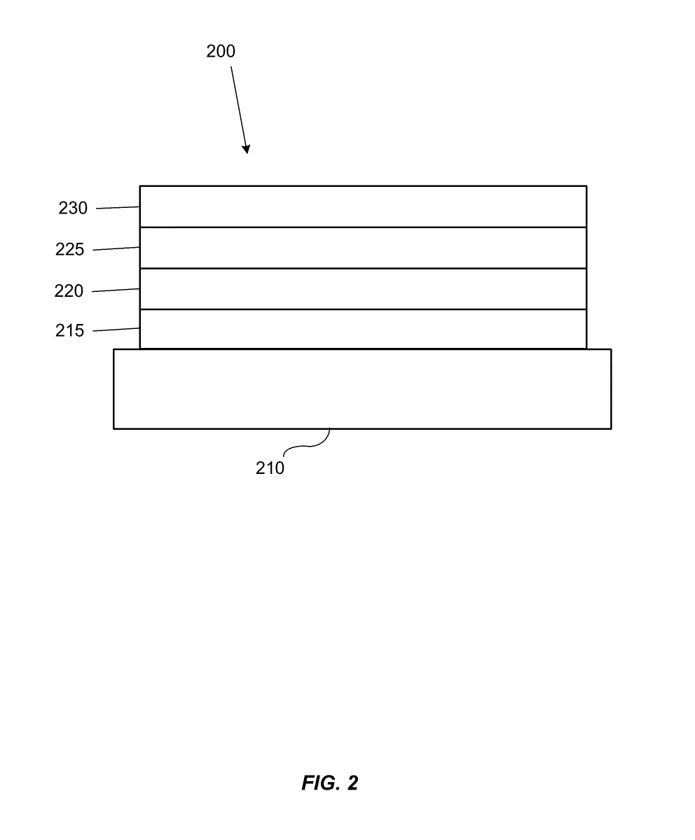

FIG. 2 shows an inverted OLED 200. The device includes a substrate 210, a cathode 215, an emissive layer 220, a hole transport layer 225, and an anode 230. Device 200 may be fabricated by depositing the layers described, in order. Because the most common OLED configuration has a cathode disposed over the anode, and device 200 has cathode 215 disposed under anode 230, device 200 may be referred to as an “inverted” OLED. Materials similar to those described with respect to device 100 may be used in the corresponding layers of device 200. FIG. 2 provides one example of how some layers may be omitted from the structure of device 100.

The simple layered structure illustrated in FIGS. 1 and 2 is provided by way of non-limiting example, and it is understood that embodiments of the invention may be used in connection with a wide variety of other structures. The specific materials and structures described are exemplary in nature, and other materials and structures may be used. Functional OLEDs may be achieved by combining the various layers described in different ways, or layers may be omitted entirely, based on design, performance, and cost factors. Other layers not specifically described may also be included. Materials other than those specifically described may be used. Although many of the examples provided herein describe various layers as comprising a single material, it is understood that combinations of materials, such as a mixture of host and dopant, or more generally a mixture, may be used. Also, the layers may have various sublayers. The names given to the various layers herein are not intended to be strictly limiting. For example, in device 200, hole transport layer 225 transports holes and injects holes into emissive layer 220, and may be described as a hole transport layer or a hole injection layer. In one embodiment, an OLED may be described as having an “organic layer” disposed between a cathode and an anode. This organic layer may comprise a single layer, or may further comprise multiple layers of different organic materials as described, for example, with respect to FIGS. 1 and 2.

Structures and materials not specifically described may also be used, such as OLEDs comprised of polymeric materials (PLEDs) such as disclosed in U.S. Pat. No. 5,247,190 to Friend et al., which is incorporated by reference in its entirety. By way of further example, OLEDs having a single organic layer may be used. OLEDs may be stacked, for example as described in U.S. Pat. No. 5,707,745 to Forrest et al, which is incorporated by reference in its entirety. The OLED structure may deviate from the simple layered structure illustrated in FIGS. 1 and 2. For example, the substrate may include an angled reflective surface to improve out-coupling, such as a mesa structure as described in U.S. Pat. No. 6,091,195 to Forrest et al., and/or a pit structure as described in U.S. Pat. No. 5,834,893 to Bulovic et al., which are incorporated by reference in their entireties.

Unless otherwise specified, any of the layers of the various embodiments may be deposited by any suitable method. For the organic layers, preferred methods include thermal evaporation, ink-jet, such as described in U.S. Pat. Nos. 6,013,982 and 6,087,196, which are incorporated by reference in their entireties, organic vapor phase deposition (OVPD), such as described in U.S. Pat. No. 6,337,102 to Forrest et al., which is incorporated by reference in its entirety, and deposition by organic vapor jet printing (OVJP), such as described in U.S. patent application Ser. No. 10/233,470, which is incorporated by reference in its entirety. Other suitable deposition methods include spin coating and other solution based processes. Solution based processes are preferably carried out in nitrogen or an inert atmosphere. For the other layers, preferred methods include thermal evaporation. Preferred patterning methods include deposition through a mask, cold welding such as described in U.S. Pat. Nos. 6,294,398 and 6,468,819, which are incorporated by reference in their entireties, and patterning associated with some of the deposition methods such as ink jet and OVJD. Other methods may also be used. The materials to be deposited may be modified to make them compatible with a particular deposition method. For example, substituents such as alkyl and aryl groups, branched or unbranched, and preferably containing at least 3 carbons, may be used in small molecules to enhance their ability to undergo solution processing. Substituents having 20 carbons or more may be used, and 3-20 carbons is a preferred range. Materials with asymmetric structures may have better solution processibility than those having symmetric structures, because asymmetric materials may have a lower tendency to recrystallize. Dendrimer substituents may be used to enhance the ability of small molecules to undergo solution processing.

Devices fabricated in accordance with embodiments of the invention may be incorporated into a wide variety of consumer products, including flat panel displays, computer monitors, televisions, billboards, lights for interior or exterior illumination and/or signaling, heads up displays, fully transparent displays, flexible displays, laser printers, telephones, cell phones, personal digital assistants (PDAs), laptop computers, digital cameras, camcorders, viewfinders, micro-displays, vehicles, a large area wall, theater or stadium screen, lighting fixtures, or a sign. Various control mechanisms may be used to control devices fabricated in accordance with the present invention, including passive matrix and active matrix. Many of the devices are intended for use in a temperature range comfortable to humans, such as 18 degrees C. to 30 degrees C., and more preferably at room temperature (20-25 degrees C.).

The materials and structures described herein may have applications in devices other than OLEDs. For example, other optoelectronic devices such as organic solar cells and organic photodetectors may employ the materials and structures. More generally, organic devices, such as organic transistors, may employ the materials and structures.

The terms halo, halogen, alkyl, cycloalkyl, alkenyl, alkynyl, arylkyl, heterocyclic group, aryl, aromatic group, and heteroaryl are known to the art, and are defined in U.S. Pat. No. 7,279,704 at cols. 31-32, which are incorporated herein by reference.

Additional definitions for terms as used in this application are provided as follows:

As used herein, the term “commonly addressable” may refer to configurations in which the current in one device (or group of devices) cannot be changed without changing the current in another device (or group of devices). The current and/or current density supplied to each device or group of devices need not be the same. However, once the current is established for one device or group of devices, this also sets the current for the other groups. That is, “commonly addressable” may refer to configurations in which there is essentially a single switch that controls whether the devices are “on” or “off” (i.e. whether the devices are driven by a current). The devices or groups of devices may not thereby be individually activated and/or deactivated. In this regard, the OLEDs may also be dimmed (e.g. by reducing the current supplied to the device or portions thereof), but in such a case, each of the OLEDs are dimmed together. That is, if one OLED is dimmed, each of the other OLEDs is also dimmed, though not necessarily by the same proportion. This may be in contrast to devices or groups of devices that are individually addressable.

As used herein, “duv” is a general term that may be used to quantify the difference in chromaticity between different lighting devices (such as OLED displays or components of

OLED displays). This can quantified in terms of duv=√(Δu′²+Δv′²), where (u′, v′) are the coordinates of the different lighting devices in the CIE 1976 (L*, u*, v*) color space chromaticity diagram. The CIE 1976 (L*, u*, v*) color space is used in preference over the CIE 1931 XYZ color space because in the CIE 1976 (L*, u*, v*) color space chromaticity diagram, distance is approximately proportional to perceived difference in color. An alternative name for the CIE 1976 (L*, u*, v*) color space chromaticity diagram is the CIE 1976 UCS (uniform chromaticity scale) diagram. The conversion between coordinates in these color spaces is very simple: u′=4x/(−2x+l2y+3) and v′=9y/(−2x+l2y+3), where (x, y) are the coordinates of the CIE 1931 XYZ color space chromaticity diagram.

The term “Duv” is a specific example of “duv.” In this regard, Duv refers to the minimum distance in the CIE 1976 (L*, u*, v*) color space chromaticity diagram of the lighting device chromaticity from the blackbody curve. That is, Duv is a measure of the difference in chromaticity between a lighting device and a blackbody radiator of equivalent correlated color temperature. This can be quantified in terms of Duv=√(Δu′²+Δv′²)=√((u1′−u2′)²+(v1′−v2′)²), where (u1′, v1′) are the coordinates of the lighting device, and (u2′, v2′) are the coordinates of the blackbody curve at the minimum distance from the lighting device in the CIE 1976 (L*, u*, v*) color space chromaticity diagram.

As used herein a “gobo” may refer to any device that goes before a light to produce patterns of light and shadow. For instance, a gobo may comprise a physical template slotted around (or placed in front of) a lighting source that may be used to control the shape, color, intensity, or other properties of emitted light. A gobo may comprise patterned holes or shapes through which light passes, which may be placed in a beam of light (i.e. the optical path) to allow only the desired “shape” or pattern through (while blocking the rest of the light) thereby casting a specific shadow/light into the space. A gobo may comprise a thin sheet of transparent plastic or glass or opaque metal that is patterned to selectively allow light transmission. A gobo may also comprise transparent or translucent materials comprising color filter materials such that light having a certain wavelength may pass through only certain portions of the gobo, while other wavelengths may be absorbed and/or reflected by the gobo. For example, a gobo may comprise a color printed image that has different portions of varying color density. A gobo may also comprise down conversion materials that selectively absorb light having certain wavelengths and then re-emit light at selected longer wavelengths. It should be understood that these examples are provided by way of non-limiting illustration.

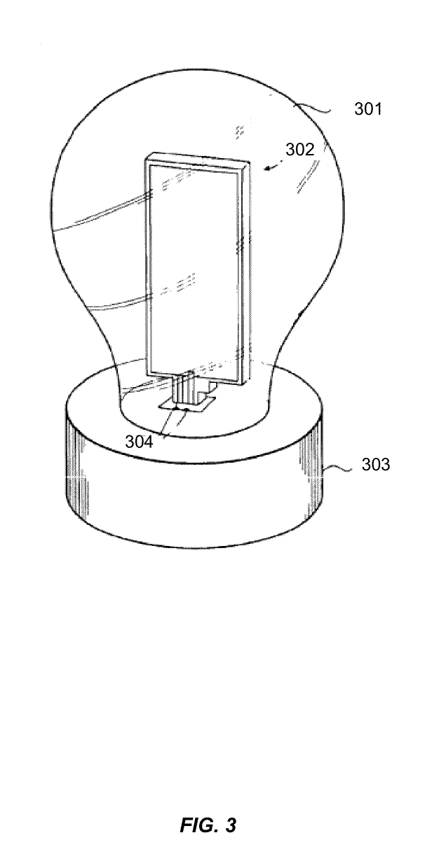

Examples of gobos are provided in FIGS. 3-6, and described herein. With reference to FIG. 3, an OLED light source 302 is shown disposed within a housing 301. The housing, in some embodiments, may comprise a gobo such that light emitted by the OLED light panel 302 emitted in substantially all directions (except in a direction toward the support structure 303 that couples the gobo 301 and OLED light panel 302) may be altered by the optical properties of the gobo 301. The support structure 303 may comprise a conductive path 304 that may be coupled to a power source within the support structure 303, or may connect the OLED light panel 302 to an external power source. This device is described in further detail in U.S. Pat. No. 6,819,036 filed May 28, 2002 to R. S. Cok, which is hereby incorporated by reference in its entirety.

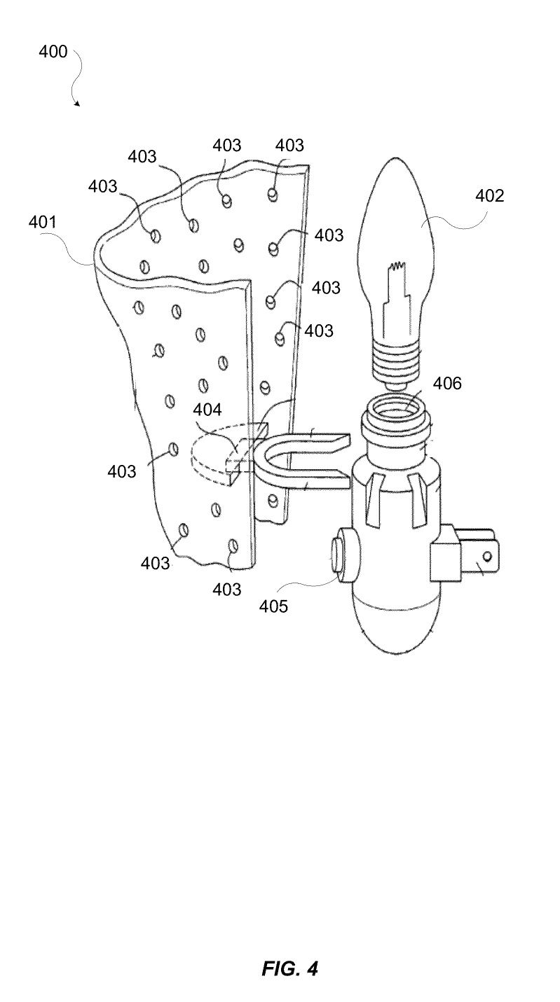

FIG. 4 shows a gobo 401 coupled to a light source 402 comprising an incandescent lamp. The gobo includes a plurality of portions 403 that permit light to be transmitted through relatively unchanged, whereas the other portions of the gobo 401 block light emitted by the light source 402 (this may be considered a stencil gobo). The light source 402 and the gobo 401 are coupled using a connector 404. The incandescent light source 402 is inserted into a cavity or a recess 406 of a support structure 405. In this manner, when the first source 402 is activated, the device 400 may provide a pattern of light (e.g. the light that is transmitted through the openings 403) that may be perceived by a viewer. This device is described in further detail in U.S. Pat. No. 7,568,829 filed Aug. 3, 2006 to T-L. Chen, which is hereby incorporated by reference in its entirety.

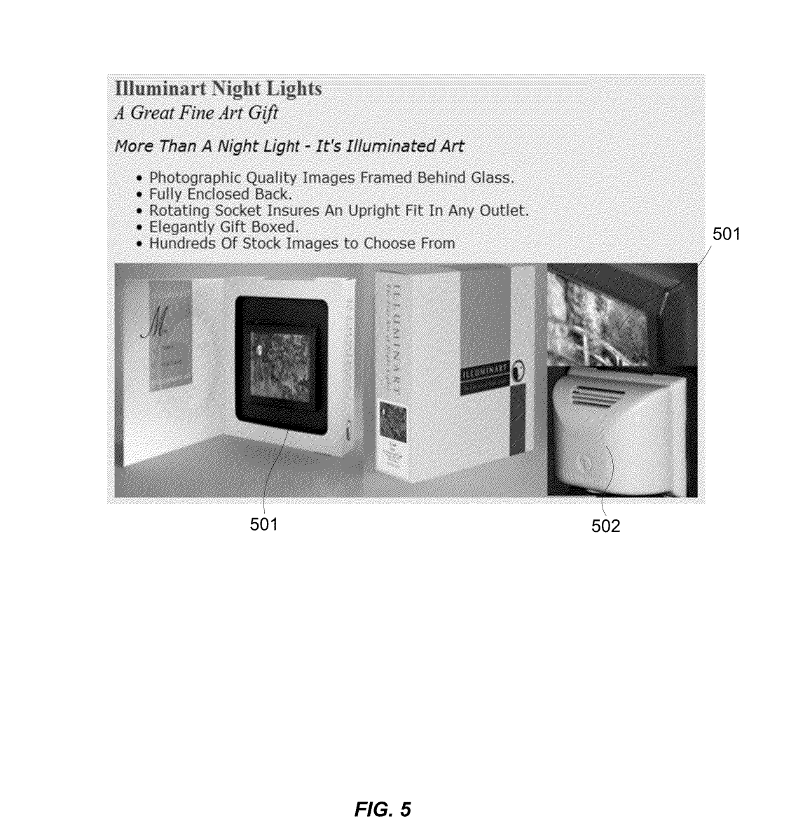

FIG. 5 is a photograph of a commercial advertisement for another embodiment of a device comprising a gobo 501. The gobo 501 is shown as comprising an image on the front of the device. An incandescent bulb is mounted in a plastic housing 502 behind the picture. Light passes from the bulb through the picture. A sheet of glass (not shown) is placed between the bulb and the gobo 501 to protect the gobo 501 from heat damage. A white diffuser sheet is placed between the bulb and the gobo 501 to scatter the light more uniformly.

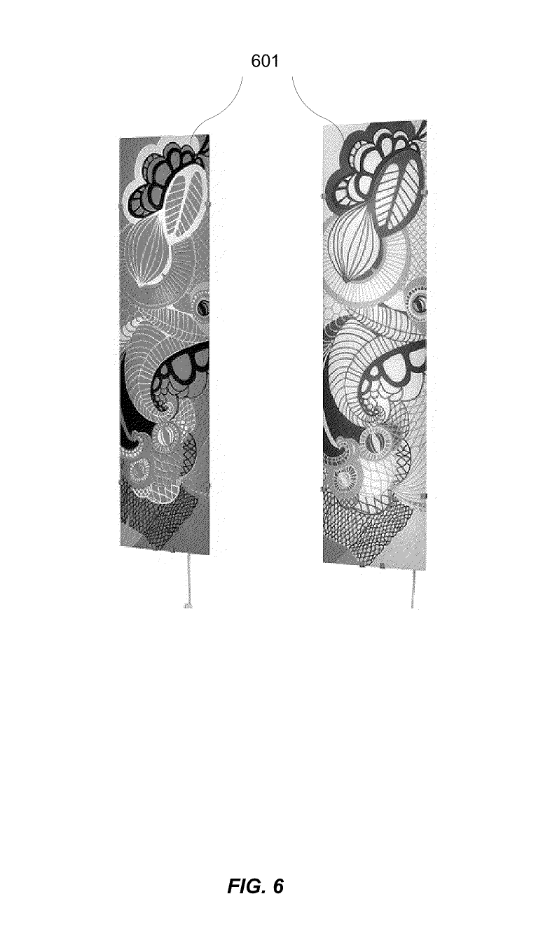

FIG. 6 shows another example of a gobo 601. The gobo 601 comprising a glass panel is placed in front of two lamps (not shown). The glass panel is patterned, so as to allow light of certain wavelength to pass through certain portions of the gobo, while blocking (or partially blocking) light having different wavelengths. In this manner, when the lamps are activated, the gobo may be illuminated and provide a color image perceivable by a viewer.

As used herein, the term “optically coupled” may refer to when a light source (such as an OLED lighting panel) and gobo are disposed in relation to one another such that light transmitted by the light source is transmitted through at least a portion of the gobo and/or the gobo is illuminated by the first light source. That is, the gobo (or a portion thereof) is disposed in the path of light emitted by the first light source.

A light source comprising an organic light emitting device (such as an OLED light panel) in combination with a gobo may be provided. As described above, a gobo (or Go Between or Goes Before Optics) may, for instance, refer to a device that goes before a light source (i.e. it may be disposed between a light source and a viewer) so as to produce patterns of light and shadow. It may be preferred in some embodiments that the gobo comprises a thin sheet of transparent plastic or glass that may be patterned so as to selectively permit light transmission. However, embodiments are not so limited (as described in detail below). It may be preferred in some embodiments that the gobo is coupled (e.g. attached) to an OLED light panel, or otherwise disposed adjacent to an OLED light panel. In some embodiments, a gobo could be patterned so as to control the intensity of light and/or the color of the light.

The inventors have discovered that an OLED light source (such as an OLED light panel) may be ideally suited for devices and applications comprising a gobo. Some examples of the characteristics and advantages of the use of OLED lighting devices that the inventors have recognized may provide when used in combination with a gobo are described herein for illustration purposes only. Embodiments need not provide each of the exemplary features described below, and there may be additional functionality that such embodiments provide that is not listed or described.

In this regard, OLED light panels may have a thin form factor, which the inventors have found may enable their use in combination with a gobo in applications for which other lighting devices (such as those that comprise an incandescent lamp) may not be as well-suited. For instance, the device may be stored in small places (e.g. a purse or pocket), and may be used in small areas. OLED light panels may be flexible, which the inventors have found may (for instance, when used in combination with a flexible gobo) provide for a more robust design and easier transport in comparison to a rigid device. OLED light panels can be color tunable. The inventors have found that this may, in some instances, provide a manner in which variations in a perceived image or pattern that may be generated by the device (or may provide a manner to adjust the output of the lighting device so as to maximize the resulting light transmission for a give purpose). In contrast, other lighting devices may be more limited (e.g. other lighting devices may only have a single light transmission property).

In some instances, OLED lighting devices may be inherently diffuse with relatively low power density, which the inventors have found may enable illuminated images to be observed directly (i.e. a viewer in some embodiments may look directly at the gobo, in contrast to embodiments where the gobo is used to project an image or pattern onto a surface) without some of the problems of glare that may result when using other lighting devices. In some instances, OLED lighting devices may be highly uniform (e.g. OLED lighting panels may have grater than 90% luminance uniformity and excellent color uniformity with duv value of less than 0.010 over a large area), which the inventors have found may provide for a more uniform illumination of the gobo (for example, when the gobo comprises an image, an OLED may more effectively illuminate each portion of the image). In some instances, OLED light panels may be dimmable (and/or locally dimmable), which the inventors have found may again enable a device comprising a gobo and an OLED lighting device to provide variation of the resulting transmitted light and/or image without using multiple gobos and/or lighting devices.

OLED lighting devices may also operate having low (and uniform) surface temperature in comparison to other lighting devices. The inventors have found that this may enable embodiments to use gobos that comprise a wider variety of materials (such as low-cost plastic or other materials that may be generally more susceptible to heating). The inventors have also found that OLED lighting devices that have a low operating temperature may also enable the gobo to be placed in direct contact with, or relatively close to, the OLED light panel. This may permit for both smaller devices as well as smaller gobos, as placing the gobo closer to the light source reduces the area that may be required to optically couple the gobo to the same amount of light transmission from the light source. In some embodiments, the gobo may be placed close to the OLED lighting device without the use of cooling or thermal management, which the inventors have found may further reduce the size of the device, reduce the components needed for the device, and simplify the manufacturing process.

In some instances, OLED lighting devices may produce low intensity lighting, which the inventors have found may reduce the fading of a gobo that is optically coupled to the OLED panel (for instance, for a long period of time) in comparison to other high intensity light sources. OLED light panels may be highly efficient such that the power consumption for the device is relatively low in comparison to the use of other devices, which the inventors have found may be beneficial, particular for embodiments where the device may be activated for long periods of time (e.g. billboards, advertisements, night lights, etc.). In some embodiments, where a white OLED light panel is utilized, the OLED light panel may have a broadband emission spectra, with no gaps in the visible spectrum, such that all of the image colors can be rendered. This may provide improved fidelity compared to other light sources that have emission spectra with multiple narrow emission peaks.

As noted above, a device comprising a gobo and an OLED lighting device may (but need not necessarily) comprise some or all of these properties which the inventors have discovered may generally make OLED light panels ideally suited for use in combination with a gobo. Again, the above listing was provided for illustration purposes only, and need not be considered as requiring any device contain each of these features.

The gobo that is optically coupled to the first device may take many forms, as was described above. In some embodiments, the gobo may comprise a stencil that has portions that may either allow light from an OLED panel to pass or that may block the light entirely, such as the embodiment shown in FIG. 4. This may, for instance, produce a silhouette with one region that emits light, and one region that is dark.

In some embodiments, the gobo may allow for control of grayscale. For instance, embodiments may provide the ability to control light transmission from an OLED panel through the gobo. Certain areas (e.g. potions) of the gobo may allow for higher light transmission relative to other portions (and conversely, other portions may allow for lower light transmission). This may result in an illuminated grayscale image. In some embodiments, a gobo that allows for control of grayscale may be optically coupled to a color tunable OLED light panel.

In some embodiments, the gobo may allow for the control of color. This may be achieved by, for instance, using one or more color filters that allow for selective wavelengths of light from an OLED panel to pass through the gobo (and blocking or reducing transmission of light having different wavelengths). In some embodiments, a single color filter could be used on its own or could be used in combination with a stencil or grayscale control such as those mentioned above. Similarly, in some embodiments, multiple color filters could be used by themselves, or could be used in combination with a stencil or grayscale control.

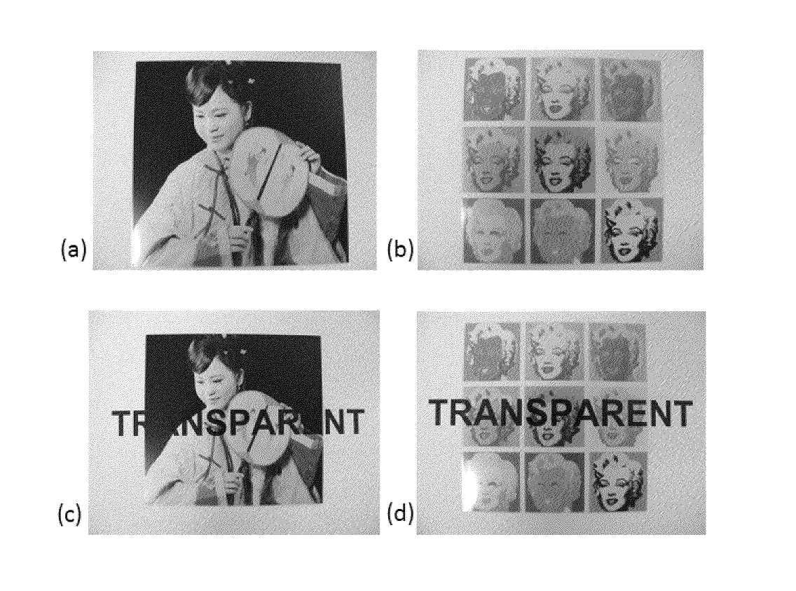

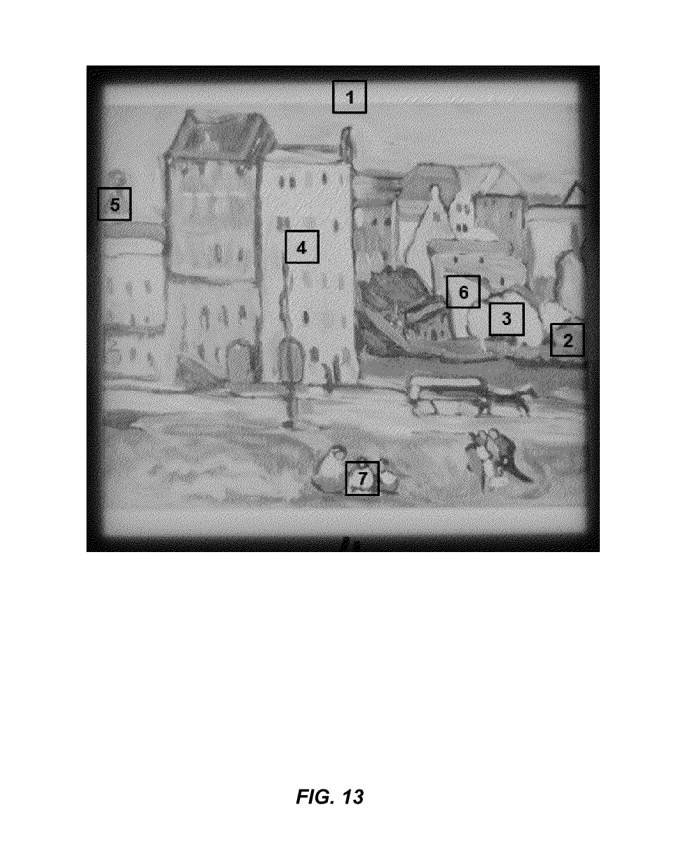

For example, a relatively straightforward and low-cost manner of demonstrating grayscale and color control may be to form a gobo by printing a color image onto a transparent plastic film. Examples of this are shown in FIGS. 12 and 13, and described below. When placed in front of a white OLED light panel, an illuminated image may thereby be produced. In some cases (such as when a printed image is used), the density of the print may determine the color saturation. That is, for instance, high density printing may give saturated color; while low density printing may give un-saturated color. In some embodiments, the transparent plastic film could be replaced at relatively low-cost, permitting the illuminated image to be changed. Embodiments may have widespread application in fields such as, by way of example, decorative lighting, night lighting and signage markets. However, a gobo may comprise any material, such as for instance glass, plastic or metal material. An example of such an embodiment is shown in FIG. 6, where the gobo 601 comprises colored glass.

Embodiments may provide for a gobo in combination with an OLED lighting device (e.g. optically coupled), where the OLED may not comprise a display. That is, for instance, the OLED lighting panel may not comprise complex circuitry in the form of TFTs and/or may not comprise individually addressable pixels or sub-pixels. This may decrease manufacturing cost while permitting images (and in some instances, even complex color images) to be displayed. By omitting the TFTs, the total emissive area on the OLED lighting panel may also be increased. This may provide increased total light output and improved power efficiency and lifetime. In addition, in some embodiments, the gobo may also be relatively inexpensive, and may be removably coupled to the lighting device so as to allow for changing of the gobo (and thereby the image or pattern produced). As described in more detail below, in some embodiments, and unlike typical displays, the features of the image may be defined by the pattern and properties of the gobo, and not by the OLED panel. However, in some embodiments, the OLED panel may be used to control the brightness of the image and to a certain extent, the color hues of the image.

In some embodiments, the OLED panel may be dimmable, locally dimmable and/or color tunable. As noted above, the inventors have found that these features may enable the device to be adjusted to suit a particular application and/or the needs of a user of the device.

### Exemplary Embodiments of Devices Comprising an OLED Lighting Device in Combination with a Gobo

Described below are exemplary embodiments of devices comprising a gobo in combination with an OLED lighting device. The embodiments described herein are for illustration purposes only and are not thereby intended to be limiting. After reading this disclosure, it may be apparent to a person of ordinary skill that various components as described below may be combined or omitted in certain embodiments, while still practicing the principles described.

In this regard, a first device may be provided that includes a first light source comprising one or more organic light emitting devices (OLEDs) and a gobo that is optically coupled to the first light source. The gobo and the first light source may be disposed relative to one another in any manner. For instance, the gobo need not be directly coupled to the first light source, but may be disposed relative to the first light source such that it is within the optical path of at least some of the light emitted from the first light source. However, in some embodiments, the gobo may be coupled directly (or indirectly) to the first light source using any suitable means, such as, for instance, through the use of adhesives, fasteners, or structural components (such as support structures or interlocking components). The gobo may allow differential transmission of light emitted by different parts of the first light source so as to create a fixed variation in the light emitted by the first device. That is, for instance and as described above, the light emitted from the first light source may pass through, be blocked, be partially blocked, and/or may be altered in any other way (such as, for instance, altering the chromaticity of the light emitted, the intensity, the direction of propagation, etc.) by portions of the gobo so as to create an image or pattern that may be perceivable by a viewer.

In this manner, the inventors have discovered that devices that comprise a gobo in combination with a light source comprising one or more OLEDs may provide advantages and improved devices for displaying images (including full color images), patterns, or other light transmission affects that may be perceivable by a viewer. Embodiments that comprise some of these features are further described below by way of non-limiting examples.

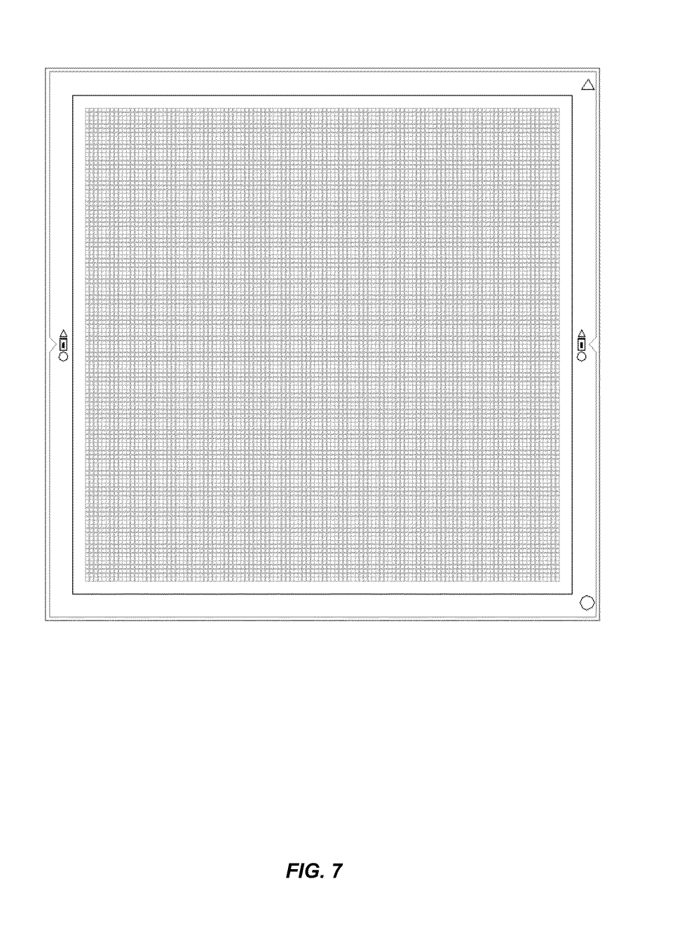

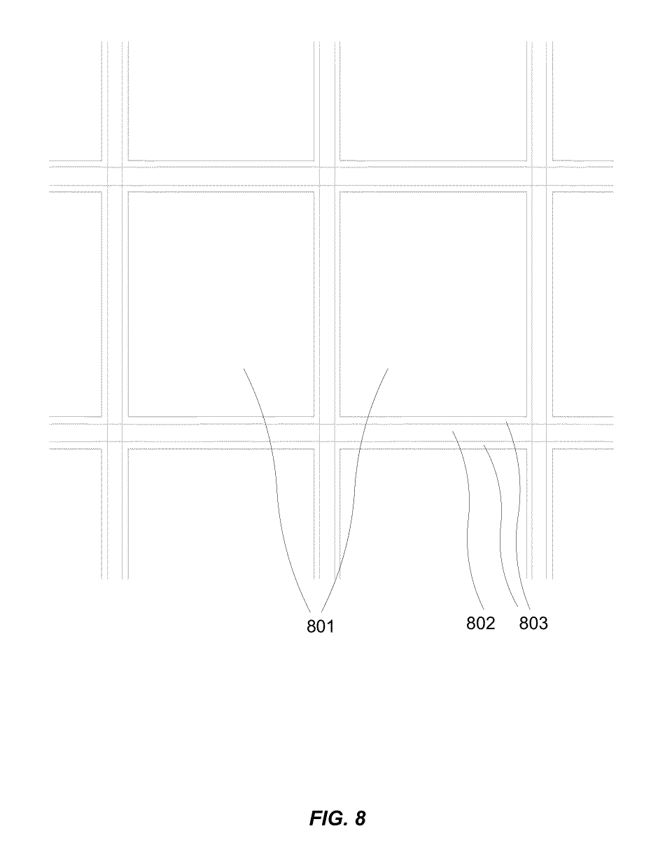

The first light source may comprise any suitable form and number of OLEDs, including by way of example, stacked OLEDs (SOLEDs), top or bottom emitting devices, and transparent OLEDs (TOLEDs). Moreover, the first light source may comprise OLEDs having any number of EL materials. For instance, in some embodiments, the one or more OLEDs may emit white light and may thereby comprise two EL materials (e.g. the emission spectrum of the EL materials may have peak wavelengths corresponding to blue and yellow light) or three EL materials (e.g. the emission spectrum of the EL materials may have peak wavelengths corresponding to blue, green, and red light). However, embodiments are not so limited, and the OLEDs may comprise any EL material that emits a color suitable for the desired application. The one or more OLEDs may also, for instance, comprise an RGB stripe design or other panel layout. An exemplary panel design is shown in FIGS. 7 and 8 and described below.

In some embodiments, in the first device as described above, the first light source comprises a plurality of organic light emitting devices that are commonly addressable. That is, for instance, unlike displays that may comprise complex circuitry so as to individually address each OLED (e.g. each pixel or sub-pixel) so as to render an image, embodiments disclosed herein may display an image without the need for such circuitry. As noted above, this may greatly reduce manufacturing costs and increase the lifetimes of the devices. Although embodiments may not have the same capability as a display in regards to the number of images that may be generated, the decrease in cost and complexity of embodiments comprising an OLED in combination with a gobo may make such embodiments preferred for applications where, for instance, only a select few images need to be displayed. Some examples may include billboard advertisements, informational signs, warning indicators, nightlights, aesthetic decorations, etc.

In some embodiments, in the first device as described above comprising a gobo optically coupled to a first light source having one or more OLEDs, all of the OLEDs that are optically coupled to the gobo are commonly addressable. That is, for instance, the first device may comprise one or more OLEDs, and the OLEDs, for which the gobo is disposed in the optical path of at least some of the light emitted by those OLEDs, may all be commonly addressable. However, some embodiments may have one or more OLEDs that are not commonly addressable that are not optically coupled to the gobo. For instance, the device itself may comprise one or more indicator lights that may display, for example, the status of the first device, etc. In some embodiments, in the first device as described above, all of the organic light emitting devices disposed on the first device are commonly addressable. That is, the device may not comprise any additional OLEDs that are not commonly addressable, such that when current or voltage is supplied to one OLED, it is supplied to all of the OLEDs in the device. In addition, to the extent that each OLED is optically coupled to the gobo, this may result in a highly efficient device, as the light generated by each OLED may be utilized to illuminate a portion of the gobo to form an image or pattern.

In some embodiments, in the first device as described above, the first light source emits light that has a Duv value that is less than 0.010. As noted above, Duv is the measure of the distance of the chromaticity of the light emitted by a device from the Planckian locus. It may be preferred in some embodiments that the light emitted by the first light source comprise near white light. For instance, if the gobo comprises a color image (or a plurality of color filters), a device that emits near white light may reproduce the color image with greater fidelity in comparison to a light source with higher Duv value. Moreover, white light may be relatively neutral in terms of the gobo that may be optically coupled to the first light source, such that in some instances a device that emits near white light may be used with multiple gobos more or less interchangeably without reduction in performance.

In some embodiments, in the first device as described above, the first light source is color tunable. That is, as noted above, “color tunable” may refer to when the chromaticity of the first light source may be adjusted by, for instance, changing the current or voltage supplied to the device or portions thereof. Embodiments may thereby provide the ability to adjust the chromaticity of light emissions of the first device. This may provide some embodiments with greater flexibility and adaptability so as to be suitable for use in multiple and varied applications. For instance, if a particular application for the first device requires only red light to be emitted from the first light source, and another application requires only blue light, a first light source that comprises, for instance, RGB stripe OLEDs, may be color tuned to address each of these needs without requiring a separate light source or device. In addition, a color tunable first light source may provide the ability to adjust the chromaticity of the light emitted by the light source to compensate for differential aging of the different emissive materials of the OLED(s).

In some embodiments the color tunable first light source may include RGB stripe OLEDs and a color mixing layer disposed between the RGB OLEDs and the gobo. The color mixing layer may comprise a light scattering film, such as a diffuser sheet. The color mixing layer may be used to mix the components of red, green and blue to form white light. The light source may be tuned to emit white light across a range of color temperatures by controlling the relative contributions of R, G and B stripes. In some embodiments, only one of the stripes may be powered at any one time to produce R, G or B emission from the light source. In some embodiments, two of the stripes may be powered at any one time.

In some embodiments a color tunable OLED light source may be used in combination with a gobo with a grayscale pattern. The gobo may, for instance, be used to control localized light intensity, while the light source may be used to control emission color.

In some embodiments, in the first device as described above where the first light source emits white light having a Duv that is less than 0.010, the first light source may also be color tunable between a correlated color temperature (CCT) of approximately 2800 K to 9000 K. That is, some embodiments may provide a first device that is color tunable such that the first light source may emit near white light having a range of CCT values—thereby providing a first device with the capability to provide both warmer and cooler white light depending on the needs of a desired application. In some instances, it may be preferred to use a warmer white light to reduce the amount of blue light needed (as the blue emissive material may often limit the lifetime of the first device in some OLED devices), but still provide the flexibility of providing a cooler white light as required. It may be preferred in some instances, that the first light source may be color tunable between a correlated color temperature (CCT) of approximately 3500 K to 6500 K. This range of CCT values may correspond generally to the range of many commercial embodiments (such as the desired range of values for advertisements and billboards). Moreover, although having a smaller range of CCT values than the first light source may be tuned to may reduce the number of applications that such embodiments may be suitable for, the smaller range may provide the advantage of reducing the complexity of the device and thereby reducing manufacturing costs.

In some embodiments, in the first device as described above comprising a gobo optically coupled to a first light source, the first light source is dimmable. By “dimmable,” it is generally meant that the luminance of the first light source may be increased or decreased based on the amount of current (or voltage) that drives the first light source or portions thereof. Similar to embodiments that are color tunable, embodiments that comprise a dimmable light source may provide increased flexibility for use of the first device in multiple applications. For instance, it may be desirable that when the first light source is optically coupled to one gobo, it has a lower luminance level in comparison to when the same light source is optically coupled to a different gobo. In some embodiments, other factors may affect the desired luminance level of the device—for instance, it may be desirable that in dark environments (e.g. at night), the first light has a lower luminance level in comparison to when in brighter environments (e.g. during daylight hours). Moreover, a first device comprising a light source that is dimmable may be operated only at a luminance level that is needed, which may be less than the maximum luminance level of the first light source. This may reduce power consumption and also increase the lifetime of the first light source. As noted above, traditional light sources (such as incandescent lamps) may not provide such functionality (or may be limited) and thereby the inventors have recognized that providing a dimmable light source using one or more OLEDs may provide the aforementioned advantages to some embodiments.

In some embodiments, in the first device as described above, the first light source may be locally dimmable. By “locally dimmable” it is generally meant that the luminance of portions of the first light source may be increased or decreased independently of other portions of the first light source. In this manner, it may be possible to produce multiple images using the same gobo and the same light source comprising a plurality of OLEDs by simply altering the brightness of different portions of the first light source.

In some embodiments, in first device as described above comprising a gobo optically coupled to a first light source, the first light source may comprise multiple OLEDs (or groups of OLEDs) disposed on multiple substrates. In some embodiments, OLEDs on each substrate may be commonly addressable, but OLEDs disposed on different substrates may be individually addressable. This may enable a large area light source comprising numerous OLED light panels that may be individual addressed such that the luminance of each OLED light panel may be individually controlled and may, for instance, allow for localized dimming of the first light source. In some embodiments, where the first light source comprises multiple OLED panels, the first light source may be used in combination with one gobo or multiple gobos. In some embodiments, where the first device comprises multiple gobos, the luminance of each OLED panel could be controlled according to the luminance requirements of each gobo that is optically coupled with one or more OLEDs. In some embodiments, where the first device comprises a single gobo and multiple OLED panels, the luminance of each OLED panel could be controlled according to the luminance requirements desired for a particular section (or sections) of the gobo optically coupled to each OLED (e.g. particular areas of a displayed image). In some embodiments, a change in the brightness of the device (or a portion thereof) may not substantially affect the chromaticity of the light emitted there from (that is, it may not be perceivable to a viewer).

As noted above, use of a first light source (comprising one or more OLEDs) that is optically coupled to a gobo may provide advantages that may be related to the reduced operating temperatures and/or the reduced form factor of such devices. In some embodiments, in the first device as described above, a first distance between a portion of the light emitting zone of first light source and a portion of the gobo may be less than 1 cm. As used herein, the “light emitting zone” of the first light source may refer to the portion of the light source where photons are generated. The position of the “light emitting zone” is generally discussed in terms of position within the device in a direction perpendicular to the plane of the device. In the case of OLEDs, the light emitting zone is generally a part or all of one or more emissive layers (EML). While in many instances the light emitting zone may correspond to a recombination zone of an OLED, where electronic charge recombines to form exciton states, in some instances excitons may migrate away from the recombination zone prior to emitting light. Where the first light source comprises multiple OLEDs, the “light emitting zone” of the first light source may comprise the light emitting zone of each of the OLEDs (that is, the light emitting zone need not be a continuous region of the first light source, but merely refers to each region in the first light source where photons are generated). Thus, as used herein, a “portion of the light emitting zone of the OLED” may refer to a portion of the area in which photons are generated in the first light source.

The inventors have discovered that OLEDs, which may operate at relatively low temperatures, may be located at shorter distances from the gobo. This may be, for instance, because the heat generated by the OLEDs may not be sufficient to alter or otherwise affect the composition of the gobo even at short distances, which may not be the case when other light sources (such as an incandescent lamp) are used. That is, in some instances the gobo may comprise a thin plastic material, and thereby if excess heat is generated by the first light source, it may damage or destroy the characteristics of the gobo (e.g. its shape, chemical properties, any adhesive used to couple the gobo to the light source, etc.). When traditional light sources are used with such gobos, the gobo is typically disposed at such a distance that the generated heat would be mostly dissipated, and/or a heat management device is also included. However, OLEDs, and in particular phosphorescent OLEDs, may operate at low enough temperatures that the gobo may not only be disposed at short distances from the first light source, but the gobo may also comprise an inexpensive thin plastic or glass material. This may reduce the cost of such a device in comparison to devices which use higher temperature light sources, where gobos manufactured of more expensive heat resistant materials must be used or additional thermal management or separation of the light source and gobo are required. In addition, by locating the gobo close to the first light source, the size of the first device may generally be reduced.

In this regard, in some embodiments, in the first device as described above where the first light source includes a light emitting zone, the maximum distance between a portion of the light emitting zone of the first light source and a portion of the gobo may be less than 1 cm. That is, the greatest distance between a portion of the light emitting zone of the first light source (e.g. as defined above, a portion of the OLED where the photons are generated) and any part of the gobo may by less than 1 cm. In some embodiments, devices comprising a small distance between the first light source and the gobo may thereby have reduced size, which may thereby increase the portability of the first device as well as the adaptability of such devices to different applications. Moreover, in comparison to a traditional light source (such as an incandescent lamp) the size of the first light source that comprises one or more OLEDs may itself have a reduced form factor, which may further reduce the size of the first device. In some embodiments, where the maximum distance between a portion of the light emitting zone of the first light source and a portion of the gobo is less than 1 cm, substantially all of the gobo may be optically coupled to the first light source. By “substantially,” it is generally meant that at least 90% of the surface area of the gobo (i.e. the surface of the gobo that is substantially perpendicular to the propagation direction of the light emitted by the first light source) is optically coupled to (e.g. disposed in the path of the propagation of light of) the first light source. For instance, in some embodiments, where the gobo is disposed farther away from the first light source, its surface area may be increased and portions thereof may no longer be optically coupled to the first light source, which may result in portions of the gobo not contributing to the image or pattern provided by the first device. By locating the gobo at a shorter distance from the first light source, the size of the gobo may be reduced in some embodiments.

Continuing in this regard, in some embodiments, in the first device as described above that includes a gobo optically coupled to a first light source and where the first light source includes a light emitting zone, a first distance between a portion of the light emitting zone of the first light source and a portion of the gobo may be less than 3 mm. That is, a distance between at least one point on the gobo and a portion of the light emitting zone of the first light source (e.g. a portion of an OLED as defined above) may be less than 3 mm. As noted above, locating any portion of the gobo at such a small distance from the first light source may not be feasible (particularly without the use of a heat management components) when using traditional light sources; however, the inventors have recognized that because OLEDs may operate at lower temperatures (for instance, typically less than 50° C.), embodiments comprising one or more OLEDs may utilize gobos disposed at relative distances that are closer than when using traditional light sources. In some embodiments, in the first device as described above, the maximum distance between a portion of the light emitting zone of the first light source and a portion of the gobo is less than 3 mm. That is, in some embodiments, there may be no portion of the gobo that is more than 3 mm away from a portion of the light emitting zone of the first light source (i.e. a portion of an OLED as described above). That is, each portion of the gobo is within 3 mm of at least one portion of the light emitting zone of the first light source; although there may be some portions of the light emitting zone of the first light source that are located at a distance that is greater than 3 mm from a portion of the gobo. In some embodiments, the substrate itself may have a thickness of up to 1 mm, and (assuming that one is used) a light scattering layer (i.e. located between the substrate and gobo) may have a thickness up to about 1.0 mm. Thereby, for instance, should the gobo (or portions thereof) be located at a distance of 3 mm or less, in some embodiments there may be less than 1.0 mm between the gobo and the substrate or the light scattering layer. Moreover, in some embodiments, in the first device as described above where the maximum distance between a portion of the light emitting zone of the first light source and a portion of the gobo is less than 3 mm, substantially all of the gobo may be optically coupled with the first light source. Again as noted above, the closer the gobo is disposed relative to the first light source, the more straightforward it may be to optically couple larger portions of the gobo to the first light source.

In some embodiments, in the first device as described above comprising a first light source optically coupled to a gobo, the first light source and the gobo may be in physical contact. By “physical contact” it is generally meant that any part of the gobo may contact any part of the surface of the first light source. That is, there is no air gap or other material (that is not considered a part of the surface of the first light source) that is disposed between the first light source and the gobo. As used herein, the “surface” of the first light source may include the substrate and/or any other material or layers of the device that may be in physical contact with the substrate. For instance, the surface may include the anode or cathode layers, and any layers that are directly connected to the anode, the cathode, or the substrate. This language is generally intended to include embodiments of a first device where one or more thin layers of material may be placed between the substrate and the gobo, where at least one of the one or more layers is in direct contact with the substrate, and where the one or more layers do not substantially affect the performance of the gobo (including the amount of heat that the gobo receives from the operation of the first light source). That is, for instance, the additional layers between the gobo and the substrate are not intended to be used for heat management to reduce the operating temperature of the gobo (although such additional layers may have the effect of reducing the amount of heat from the first device that reaches the gobo by a small amount, the difference in the temperature of the gobo may be less than approximately 5° C. in comparison to a device that does not have the additional layers).

To further illustrate layers that may comprise a portion of the first light source, in some embodiments, a top-emission OLED may be disposed on a substrate, and anode, organic, cathode, capping, encapsulation and/or hardcoat layers may all be disposed between the gobo and the substrate. A surface of each of these layers may be considered to be a surface of the first light source. In some embodiments, a light scattering layer may be disposed between the gobo and the substrate. The light scattering layer may be used to provide light extraction efficacy enhancement and/or to improve localized luminance uniformity and may be considered a part of the first light source. For instance, in some embodiments, where a light scattering layer is disposed between the gobo and the substrate, the temperature gradient (ΔT) across the light scattering layer is expected to be less than 5° C. For example, for an OLED light panel operating with 50 1 m/W efficacy at a very high luminous emittance of 10,000 1 m/m², heat flow of approximately Q/A=200 W/m² may be expected through the light scattering layer. The temperature gradient across the light scattering layer may be given by ΔT=(Q/A).(d/λ), where d is the thickness of the light scattering layer and λ, is the thermal conductivity of the light scattering layer. A typical light scattering layer may be a thin sheet of acrylic having thickness (d) equal to about 0.5 mm and having thermal conductivity (λ) approximately equal to 0.2 W/m.K. This exemplary light scattering layer would result in an expected temperature gradient (ΔT) equal to about 0.5° C. across the light scattering layer, such that the gobo would operate at a temperature of approximately 0.5° C. lower compared to an equivalent device that does not include a light scattering layer. This difference in temperature may be considered minimal, and it demonstrates that a typical light scattering film may not act as a thermal management structure. Another way of quantifying a temperature gradient of less than 5° C. is to say that the total thermal resistance of the layers disposed between the gobo and the substrate should be less than 0.025 K/W.

In general, disposing the gobo and the surface of the first light source such that they are in physical contact may provide a device that has reduced overall size. Moreover, in some instances, the gobo and the first light source may be manufactured during the same process, such that, for instance, the gobo may be disposed on the first light source during such a process. In addition, and as detailed above, the inventors have recognized that embodiments that comprise one or more OLEDs as the first light source may have an operating temperature such that the gobo (which may comprise a thin plastic or glass material) may function for its intended purpose even when in physical contact with the first light source (and thereby potentially having a temperature approximately equal to the surface temperature of the first light source or a portion thereof).

In some embodiments, in the first device as described above where the gobo and the surface of the first light source are in physical contact, the first light source and the gobo may be in physical contact across the surface of the entire emissive area of the first light source. As used herein, the “emissive area” may refer to the area of the first light source from which light is emitted. This is illustrated in FIGS. 7 and 8 and described below. In some embodiments, the gobo may contact more of the first light source than just the surface of the emissive area, so long as the areas of the light source that emit light are in physical contact with a portion of the gobo. That is, the gobo may extend beyond the areas of the device that emit light and may contact areas of the first light source (and/or the first device) that may be disposed above non-emissive portions (such as bus lines) or along the periphery of the first light source. Examples of such embodiments may include, for instance billboards or signage wherein the gobo may be unrolled (and disposed in physical contact with) the entirety of the surface of the first light source. However, embodiments are not so limited, and such embodiments may comprise any type of gobo and device.

As was described above, in some embodiments, a gobo may comprise portions in which no material may be present (e.g. a gobo may comprise a stencil that may permit light of all wavelengths to propagate through certain portions unchanged, compared to, for example, in the absence of any gobo material). In some embodiments, portions of the gobo that are optically coupled to the first light source may be in physical contact with the surface of the first light source. This language is thereby meant to cover embodiments comprising a gobo that includes a stencil (or that may comprise areas within the gobo that do not comprise material), whereby portions of the gobo that do comprise material are in physical contact with the surface of the first light source; and portions of the surface of the emissive area of the first light source adjacent to portions of the gobo that do not comprise any material may not be in physical contact with the gobo.

In some embodiments, in the first device as described above comprising a first light source optically coupled to a gobo, at least a portion of the gobo is not in physical contact with a surface of first light source. That is, embodiments may provide that the gobo may be disposed some distance away from the first light source (e.g. at a distance of at least 3 mm from a portion of the surface of the first light source). This may, in some embodiments, enable the gobo to be coupled and decoupled to the first device without damaging or contacting the first light source. Moreover, some embodiments may also provide for the ready replacement of the first light source, without also removing the gobo. In this regard, a user may need only to replace the first light source, rather than the entire first device (or the first light source and the gobo) if only the first light source fails. Moreover, some embodiments may also provide for the ready replacement of the gobo, without also removing the first light source. In this regard, a user may need only to replace the gobo, rather than the entire first device (or the first light source and the gobo) if only the gobo fails or a different gobo is desired. In some embodiments, the maximum distance between a portion of the surface of the first light source and a portion of the gobo may be less than 1 cm and the minimum distance between a portion of the surface of the first light source and a portion of the gobo is greater than 0.1 mm. That is, for instance, in some embodiments, the gobo may be disposed close to the first light source (i.e. at least one portion of the gobo is within approximately 1 cm of a surface of the first light source), but the gobo and a surface of the first light source may not actually be in physical contact (e.g. the closest that any point on the gobo and any point on the first light source are disposed is at least 0.1 mm apart). The area between a surface of the first light source and the gobo may comprise, for instance, an air gap or any other suitable material (including for instance, a light scattering layer). In some embodiments, the maximum distance between a portion of the surface of the first light source and a portion of the gobo may be less than 1 mm.

As was noted above, the inventors have found that the use of an OLED in embodiments comprising a first light source optically coupled to a gobo may provide some advantages over other forms of light sources—including reduced operating temperature of the device. As described above, this may enable some embodiments to locate the gobo and the first light source in close proximity to one another. Moreover, in some embodiments, in the first device as described above, the first device may not comprise a cooling element disposed between the first light source and the gobo. As described above, “cooling element” may refer to a device, apparatus, or component of a device that prevents or removes heat generated by the first light source from reaching the gobo. For example, a cooling element may comprise both active and passive devices. For instance, a cooling element may comprise a material (such as glass) that is disposed between the first light source and the gobo that absorbs and/or blocks the heat generated by the first light source. Although, an OLED substrate may comprise glass or plastic, this may not be included within the meaning of a cooling element as used herein (i.e. a cooling element may be separate from components of the first light source). For instance, in some embodiments, in the first device as described above, the first light source may include a substrate and the first device may not comprise a cooling element disposed between the substrate of the first light source and the gobo. As noted above, the inventors have found that embodiments utilizing OLED devices may operate at low temperatures, and thereby in some embodiments there may be no need for a cooling element, even when the gobo and the first light source are disposed in close proximity (or even in physical contact) with one another. By not using a cooling element, embodiments may reduce manufacturing costs and/or reduce the size of the device by using less components. This may be quantified in terms of, for instance, the temperature gradient across any layers inserted between the substrate and the gobo, or in terms of total thermal resistance of the layers. In general, the temperature gradient should be greater than 5° C. for a layer (or layers) to be considered a “cooling element.” This could be determined by, for example, measuring the substrate temperature without any additional layers (e.g. portions of the substrate that are not covered by the additional layers) and then comparing this to the measured temperature on the surface of any of the additional layers.

In some embodiments, in the first device as described above comprising a first light source optically coupled to a gobo, the gobo may be disposed relative to the first light source such that the temperature of the gobo does not exceed 50° C. when the first device is in operation. As used herein, the terms “in operation” may refer to when the first device is supplied with current or voltage, and thereby emits light. Moreover, the term “in operation” is meant to cover the device when in normal operation (i.e. when the first device is in use for its intended purpose), even though embodiments may be used in a wide range of applications from small task lamps to large billboards. Therefore, in some embodiments, including embodiments wherein the gobo is in physical contact with the first light source (or in close proximity) the temperature of the gobo may remain less than 50° C. This may be due, in part, to the fact that the OLED(s) of the first light source may have an operating temperature (the surface temperature and/or the junction temperature of the OLED) below 50° C. and thereby the first device (or at least the gobo disposed therein) may have a temperature that remains below this temperature. As noted above, the inventors have discovered that this relatively low operating temperature of the first light source (and the corresponding low temperature of the gobo) may, by way of example, enable the gobo to be located in close proximity to the first light source; enable the gobo to comprise materials (such as relatively thin and inexpensive plastics or glass) that may not typically be available for use in such devices; and/or enable devices to function without the use of cooling elements. The temperature of the gobo may refer to the average surface temperature of the surface of the gobo.

Continuing in this regard, in some embodiments, in the first device as described above, the gobo is disposed relative to the first light source such that there is no part of the gobo that has a temperature that is more than 50° C. greater than ambient temperature when the first device is in operation. As used herein, “ambient temperature” may refer to the temperature of the gobo in the absence of heating due to the operation of the first light source. In some embodiments, this may be the temperature of the surrounding environment (for instance, room temperature or the temperature in an oven). The use of ambient temperature is contemplated for embodiments that may be operated in conditions that have high initial temperatures, such that although operation of the first device may not significantly increase the temperature of the gobo, the gobo is already at a high relative temperature (i.e. the ambient temperature is high). In addition, the use of the terms “no part of the gobo” may simply reference that the gobo does not comprise any component that reaches 50° C. above ambient temperature, which may be verified, for instance, by taking the surface temperature of any part of the gobo. That is, rather than taking an average temperature of the entire gobo (as may be done above), this language may reference each portion of the gobo taken separately. As noted above, in some embodiments, the increase in the temperature of an OLED in operation may be less than 50° C., and thereby the gobo (even when in close proximity to the first light source) may not have a temperature increase of greater than 50° C. In some embodiments, the gobo may be disposed relative to the first light source such that there is no part of the gobo that has a temperature that is more than 30° C. greater than ambient temperature when the first device is in operation. In some embodiments, the gobo may be disposed relative to the first light source such that there is no part of the gobo that has a temperature that is more than 20° C. greater than ambient temperature when the first device is in operation. As noted above, the inventors have found that in general the use of OLEDs may result in lower operating temperatures for the first device. In some embodiments, the inventors have found that the increase in temperature (surface and/or junction temperature) of the OLEDs may be less than 30° C. and, in some instances, may be less than 20° C. In some embodiments, the increase in temperature of the gobo may also thereby remain relatively low, even in embodiments where the gobo is located in close proximity to the first light source.

In some embodiments, in the first device as described above where the gobo is disposed relative to the first light source such that there is no part of the gobo that has a temperature that is greater than 50° C. above ambient temperature when the first device is in operation, a first distance between a portion of the first light source and a portion of the gobo may be less than 1 cm. That is, the gobo may be located in close proximity with the first light source (i.e. less than 1 cm) but because the first light source comprises one or more OLEDs, the gobo may have a relatively low temperature increase. Indeed, in some embodiments, the first device may not comprise a cooling element or other mechanism to reduce the heat of the gobo. In some embodiments, the maximum distance between a portion of the first light source and a portion of the gobo may be less than 3 mm. In some embodiments, the first light source and the gobo may be in physical contact. Again, as was described above, the inventors have found that the low increase in temperature of the first light source that comprises OLEDs may in some embodiments enable the use of gobos without the need for additional measures to prevent heating of the gobo.

As was described above, a gobo may comprise any suitable form, material, or components. For instance, in some embodiments, in the first device as described above comprising a first light source optically coupled to a gobo, light having a peak wavelength between 400 and 750 nm emitted from the first light source does not propagate through a first portion of the gobo. That is, for instance the gobo may comprise an opaque portion that does not allow light in the visible spectrum to propagate through that section of the gobo. An example of this may be stencil embodiments, such as described with reference to FIG. 4 above. Unlike gobos that comprise color filters, these portions of the gobo may block the light across the entire visible spectrum (rather than light of a particular wavelength). In some embodiments, the first portion may comprise at least 10% of the gobo. However, embodiments are not so limited, and the opaque portions of the gobo may comprise any proportion of the gobo. The gobo may also have other portions that allow some or all of the light emitted from the first light source to propagate through those portions. For instance, in some embodiments, the other portions of the gobo may comprise any suitable component, including by way of example, color filters, transparent materials having printed images thereon, no material (i.e. a hole), etc. Similarly, in some embodiments, in the first device as described above, the gobo may comprise an opaque structure that completely blocks visible light from a first portion of the light source while allowing transmission of visible light from a second portion of the light source.

In some embodiments, in the first device as described above, the first light source may include a substrate. Each of the organic light emitting devices of the first light source may include a first electrode disposed over the substrate, a second electrode disposed over the first electrode, and an organic electroluminescent (EL) material disposed between the first and the second electrode. That is, the first light source may comprise in some embodiments an OLED such as those described above with reference to FIGS. 1 and 2, and/or may comprise an OLED panel such as those shown in FIGS. 7 and 8 and described herein. The first light source may comprise more than one OLED disposed on one or more substrates, and, as noted above, the OLEDs may be commonly addressable. For instance, in some embodiments, the OLEDs may each share a common electrode (such as a blanket layer for the anode or cathode). Utilizing blanket layers for the layers of the OLEDs may in some embodiments reduce manufacturing costs, as it may decrease the number of deposition steps used during manufacturing and/or may reduce the need for use of a fine metal mask (or other deposition processes).

In some embodiments, in the first device as described above where the first light source comprises a substrate, a first and second electrode, and an organic EL material disposed between the electrodes, the substrate may be rigid or it may be flexible. In general, the substrate may comprise any suitable material, including a plastic, glass or metal material. In some embodiments, where the substrate is rigid, the gobo may be flexible. The first light source may include an emissive area and the gobo may be configured to be selectively disposed so as to be optically coupled with at least a portion of the emissive area of the first light source. The “emissive area” as noted above may refer to the area of the first light source from which light is emitted. The term “selectively disposed so as to be optically coupled” may refer to embodiments in which the gobo may be placed over and/or removed from being optically coupled to the first light source (e.g. the gobo may be “rolled” or “unrolled” or otherwise disposed over the emissive area of the first light source in some embodiments). That is, embodiments may provide a gobo that may be optically coupled and decoupled to the first light source without damaging or removing the first light source. Some embodiments may provide a first light source that may be utilized with multiple gobos, and thereby enable a device to provide multiple functions (e.g. display more than one image or pattern) without the need to replace the first light source and/or the entire first device. This may be beneficial in some embodiments, as new or replacement gobos (which may in some instances be less expensive than the light source) may be used. Such embodiments may be particularly useful where the first light source may be large and/or expensive—such as if the first device comprises an advertisement such as a billboard. A first gobo may be applied (i.e. optically coupled to the first light source) for one advertisement at a particular time; the first gobo may be removed; and then a second gobo for a different advertisement may replace the first gobo. The concept of “rolling” and “unrolling” a gobo may provide a convenient way in some embodiments to transport the gobo as well as to selectively dispose the gobo over the first light source.

In some embodiments, where the substrate is flexible, the gobo (or a portion thereof) may also be flexible. A component may be “flexible” if the substrate or the gobo may be readily molded, configured, contorted or otherwise have its shape changed without damaging (or permanently altering) the component. That is, in some instances, the substrate or gobo may assume temporary shapes, such that the substrate or gobo may return to a previous shape either with the application of another force or simply by ceasing to apply a force. In some embodiments where both the gobo and the substrate are flexible, a first device may be provided that may be stored (e.g. in a container, such as a cylindrical housing) and retrieved, transported, utilized in places where access may otherwise be difficult, etc. Some embodiments comprising flexible components may provide a first device that is less susceptible to damage, as a force may temporarily deform the first device or components thereof, rather than permanently damaging such components. The flexibility of the components may, in some instances, be defined or determined by the elasticity of the component—which is the physical property of a material that returns it to its original shape after a stress (e.g. external forces) that made it deform or distort is removed. In some embodiments, where the substrate and/or the gobo is flexible, the substrate and/or the gobo may comprise a material having a Young's Modulus (E) that is less than approximately 10 GPa. In some embodiments, in the first device as described above where the gobo comprises a flexible plastic material, the gobo may comprise at least one of: Polyethylene Naphthalate [PEN] (E=4.2); Polyethylene terephthalate [PET] (E=2.0-2.7); Poly(methyl methacrylate) [PMMA] (E=1.8-3.1); Poly(vinyl chloride) [PVC] (E=2.4-4.1); Polystyrene

[PS] (E=3.0-3.5); Polylactic acid [PLA] (E=0.4-2.8); Polypropylene [PP] (E=1.5-2.0); or Polycarbonate [PC] (E=2.6).

In some embodiments, in the first device as described above comprising a gobo that is optically coupled to a first light source, and where the gobo comprises a flexible material, at least a portion of the gobo conforms to at least a portion of the substrate. As used herein, the gobo may “conform” to a component when it has a shape that is the same as the shape of the first light source and/or the substrate of the first light source. The first light source and the gobo can, but need not be in physical contact for the gobo (or a portion thereof) to conform to the substrate. As noted above, embodiments that comprise a flexible gobo may enable the gobo to be coupled and decoupled from the first light source. Embodiments may also minimize (or at least reduce) the size of the first device. That is, for instance, by conforming to the first light source (or a portion thereof), the gobo may reduce the overall size (and/or thickness) of the first device. In some instances, a flexible gobo may maximize (or increase) the area that is optically coupled to the first light source by conforming to the first light source.

In some embodiments, where the gobo comprises a flexible material, at least a portion of the gobo substantially conforms to at least a portion of the substrate. The term “substantially” is meant to include situations in which there may be only minor differences between the shapes of the gobo and the first light source/substrate. For instance, if the first light source/substrate has a radius of curvature for at least a first portion of the substrate, then the gobo may have a radius of curvature in a corresponding portion that has a value that is within 10% of the radius of curvature of the first portion of the substrate. However, it should be understood that in some embodiments, the gobo and the first light source may have different dimensions, and thereby “conforming” may include having a similar shape, but different dimensions.

In some embodiments, where the gobo comprises a flexible material, the entire gobo substantially conforms to at least a portion of the substrate of the OLED(s) of the first light source. That is, for instance, in some embodiments the substrate and/or the emissive area may be equal to, or larger than, the area of the gobo. The gobo may thereby have a shape that conforms to only a portion of the total substrate of the first device. In some embodiments, where the gobo comprises a flexible material, the first light source may comprise an emissive area, and the entire gobo may substantially conform to a portion of the substrate that is disposed over the emissive area. That is, similar to the aforementioned embodiments, the first light source may have an emissive area that may be equal to, or larger than, the size of the gobo such that the entire gobo may conform to only a portion of the emissive area (or the substrate disposed over the emissive area). For instance, there may be portions of the emissive area that are not optically coupled to the gobo, and may thereby emit light that is not altered or otherwise subject to the properties of the gobo. This may be utilized in embodiments so as to provide an outline or a border around the gobo, where the outline comprises unaltered light that is emitted from the one or more OLEDs of the first light source, which may thereby itself provide aesthetic value. In some embodiments, multiple gobos may be optically coupled to a single light source, and thereby each gobo may have an area that is smaller than the total emissive area of the first light source (and each gobo may conform to only a portion of the emissive area of the first light source). These embodiments may provide the advantage of using a single light source to display multiple images (for instance multiple advertisements may be put onto a billboard comprising one or more OLEDs disposed on one or more substrates), and one gobo may be removed (i.e. decoupled) without affecting any of the other gobos.

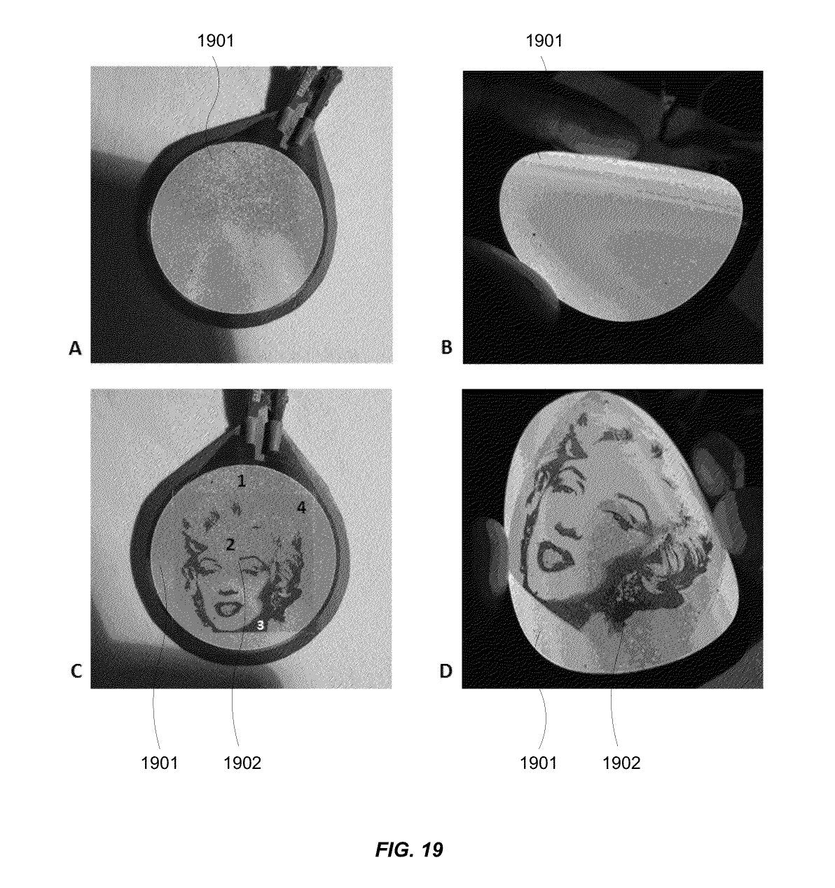

In some embodiments, where the gobo comprises a flexible material, the substrate may also comprise a flexible material and may be movably flexible between a first position and a second position. At least a portion of the gobo may substantially conform to at least a portion of the substrate in both the first position and the second position. An example of such a device is shown in FIG. 19, and described below. In some embodiments the Young's Modulus of the gobo may be less than the Young's Modulus of the substrate. The term “movably flexible” may refer to when the substrate may change position based on the application of a force and/or electrical current (or voltage). A “position” may comprise a different shape of the substrate (or a portion thereof). Embodiments may therefore provide devices that may take different shapes, but the gobo may still be optically coupled to the same (or substantially the same) portions of the first light source and display the same pattern or image. Such embodiments may provide devices that are robust and/or that may be molded or shaped to suit specific applications (for instance, the first device may be mounted and shaped around corners, into recesses, onto rounded or other irregular surfaces, etc.). In some embodiments, the entire gobo may substantially conform to at least a portion of the substrate in both the first position and the second position.

In some embodiments, in the first device as described above comprising a first light source that is optically coupled to a gobo, and where the gobo comprises a flexible material, the gobo may be laminated to the first light source. In some embodiments, the gobo is laminated to the first light source using an adhesive. For example, in some embodiments the adhesive may be transparent and may be disposed on one side of the gobo. The adhesive may be protected from being inadvertently applied to another surface by a sheet or other material which may be removed from (e.g. peeled off of) the gobo when the gobo is to be laminated to the first light source. When the sheet is removed, the adhesive may be exposed such that it can then be used to stick (i.e. couple) the gobo to an OLED panel of the first light source. In some embodiments, the gobo is directly coupled to the first light source using an adhesive. The use of the term “directly coupled” may refer to embodiments where the adhesive contacts both the gobo and the first light source, such that there are no components between the gobo and the first light source. That is, for instance, the adhesive may be in physical contact with both the gobo and the surface of the first light source. In some embodiments, the gobo is removably coupled to the first light source using an adhesive. That is, for instance, the gobo may be delaminated and replaced by another gobo (e.g. another flexible gobo). For example the adhesive may be such that it is able to hold the gobo in place during normal operation, but the adhesive does not adhere to the gobo and/or the first light source such that the gobo cannot be removed (that is, the adhesive is not so strong that it effects a permanent coupling). The use of such an adhesive to removably couple the gobo may allow for gobos to be replaced and/or reused as desired, without replacing the first device. In some embodiments, the gobo may be directly coupled to the substrate and/or the gobo may be coupled to a light scattering layer, which may itself be directly coupled to the first light source (as described above). The use of an adhesive to directly couple the gobo to the light source may generally provide the benefit of a secure connection between the gobo and the light source. Moreover, by adhering the gobo directly to the substrate of the OLED panel of the first light source, embodiments may provide that as the first light source has its shape altered or changed, the flexible gobo may also continue to conform to the substrate so as to continually remain optically coupled to the first light source. Although in some embodiments, adhering the gobo directly to the substrate of the OLED panel (or to a light scattering layer that is coupled to the substrate) may prevent or make difficult the removal and/or recoupling (or replacement) of the gobo, embodiments may further provide an adhesive that may permit the gobo to be selectively coupled and decoupled to the first light source. In some embodiments, it may be preferred that the adhesive is transparent or semi-transparent such that the image or pattern provided by the gobo is not affected by the optical properties of the adhesive.

In some embodiments, in the first device as described above comprising a first light source optically coupled to a gobo, the gobo and the first light source have a combined thickness that is less than approximately 5 cm. As used herein, the “thickness” may refer to the dimension of the first light source and the gobo in a direction that is perpendicular to a surface of both components. This is often (but not always) the smallest dimension of the gobo and the first light source. It follows that the “combined thickness” may be the total thickness of the gobo and the first light source in a direction that is perpendicular to a surface of both components. However, the combined thickness may also include any portions of the first device that are disposed between the first light source and the gobo, but that do not comprise either the first light source or the gobo—such as when there is a gap (such as an air gap) between the two components. The thickness of the first device may be directly related to the combined thickness of the gobo and the first light source, as this may be the minimum thickness that the first device may have. As noted above, the inventors have found that by utilizing OLEDs for the first light source, embodiments of the first device may have a thickness that is substantially less than the thickness of devices that use other light sources. For instance, in some embodiments, the gobo and the first light source have a combined thickness that is less than approximately 1 cm. In some embodiments, the gobo and the first light source have a combined thickness that is less than approximately 1 mm. In some embodiments, the gobo and the first light source have a combined thickness that is less than approximately 0.5 mm.

In some embodiments, in the first device as described above where the gobo and the first light source have a combined thickness that is less than approximately 5 cm, the first light source may have a luminance of at least 1000 cd/m². The “luminance” of the first light source is measured at normal incidence over the emissive area. As noted above, the inventors have found that the advantages that OLED lighting devices may provide regarding the combination of small form factor and high brightness levels may be combined with relatively thin gobos to provide embodiments of devices that have a small combined thickness while maintaining high brightness levels. These thin devices may thereby have widespread application, from uses such as for small warning displays, to providing decorative and aesthetically pleasing images and patterns, to embodiments comprising large scale advertisements. Moreover, as detailed above, the characteristics of OLED lighting devices (such as relatively low operating temperature) may further enable embodiments whereby the gobo and the first light source are disposed in relatively close proximity (recall the “combined thickness” may include any spacing between the first light source and the gobo). Indeed, utilizing other light sources (e.g. incandescent lamps) that have a luminance of 1000 cd/m² may require that the light source operate at a temperature that may be too high to locate the gobo in such close proximity. However, the inventors have found that through the use of OLEDs, embodiments may have high brightness levels, while having a combined thickness that may, in some instances, be less than 1 mm. In some embodiments, where the combined thickness of the first light source and the gobo is less than 5 cm, the first light source may have a luminance of at least 3000 cd/m². In some embodiments, where the combined thickness of the first light source and the gobo is less than 5 cm, the first light source may have a luminance of at least 5000 cd/m².

It should be understood that after reading the disclosure provided herein, a person of ordinary skill in the art may recognize that embodiments of the first device may combine one or more of the features described above. For instance, in some embodiments, for a first device as described above that comprises a first light source optically coupled to a gobo, the temperature of the gobo may not exceed 50° C. while the device is in operation at a luminance of greater than 1000 cd/m². In some embodiments, where the temperature of the gobo does not exceed 50° C. while the device is in operation at a luminance of greater than 1000 cd/m², the gobo may be disposed less than 1 cm away from a portion of the light emitting zone of first light source (or the gobo may be disposed in close proximity up to and including in physical contact with the surface of the first light source). In some embodiments, where the temperature of the gobo does not exceed 50° C. above ambient temperature while the device is in operation at a luminance of greater than 1000 cd/m², the gobo may be disposed less than 1 cm away from a portion of the light emitting zone of first light source (or the gobo may be disposed in close proximity up to and including in physical contact with the surface of the first light source). In some embodiments, where the temperature of the gobo does not exceed 30° C. above ambient temperature while the device is in operation at a luminance of greater than 1000 cd/m² (and in some embodiments, greater than 5000 cd/m²) the gobo may be disposed less than 1 mm away from a portion of the light emitting zone of first light source (or the gobo may be disposed in close proximity up to and including in physical contact with the surface of the first light source). These exemplary embodiments are provided as non-limiting examples of various combinations of the features described herein that may be made. As noted above, the inventors have found that some of the advantages of using OLEDs for the first light source may permit the configuration of embodiments of devices having one or more of the features described herein.

In some embodiments, in the first device as described above that comprises a first light source optically coupled to a gobo, the gobo may comprise a material that is not stable at temperatures that are greater than 150° C. The use of the term “stable” may reference temperatures at which the physical or chemical properties of the gobo begin to change such that it may no longer function for its intended purpose. In some embodiments, this may comprise the materials “glass transition temperature (T_{g})” and/or “melting temperature (Tₘ).” The liquid-glass transition (or glass transition temperature for short) is the reversible transition in amorphous materials (or in amorphous regions within semi-crystalline materials) from a hard and relatively brittle state into a molten or rubber-like state. T_{g} is always lower than Tₘ. In general, the gobo material in the first device may be such that the operating temperature of the gobo (i.e. the temperature of the gobo during normal operation) is below T_{g}. Example values of T_{g} are provided below for common materials that may comprise a gobo in accordance with some embodiments. In some embodiments, such as when the gobo comprises polypropylene, the components of the first device may be chosen and configured such that the gobo operates at a temperature between T_{g} and Tₘ. As described above, the inventors have found that the relatively low operating temperatures of OLED lighting devices may enable embodiments to dispose the first light source and the gobo in close proximity, while maintaining the temperature of the gobo during operation at low levels. These temperatures may be below T_{g} for most materials, including thin, inexpensive plastics. This may further provide the advantage in some embodiments of having a wider selection of materials that may be selected for the gobo, including materials that have lower T_{g} values. In some embodiments the gobo may comprise a material that is not stable at temperatures that are greater than 100° C. In some embodiments, the gobo comprises a material that is not stable at temperatures that are greater than 60° C.

Continuing in this regard, in some embodiments, in the first device as described above comprising a gobo optically coupled to a first light source, the gobo may comprise a transparent or translucent plastic. The use of an OLED lighting device and its generally low operating temperatures may not only enable the use of transparent or translucent plastics disposed in relatively close proximity, but the gobo may comprise relatively thin materials that, if used in combination with other light sources, may become physically or chemically unstable. In this regard, in some embodiments, the gobo may have a thickness that is less than approximately 1 cm. In some embodiments, the gobo may have a thickness that is less than approximately 1 mm. In some embodiments, the gobo may have a thickness that is less than approximately 0.5 mm. Typically, the thinner the gobo, the thinner the overall device, and a thinner gobo may also reduce the cost of manufacturing and/or reduce unwanted loses associated with light propagation through the material.

In some embodiments, in the first device as described above where the gobo comprises a transparent or translucent plastic material, the gobo may comprise at least one of: Polyethylene Naphthalate [PEN] (Tg=120° C.); Polyethylene terephthalate [PET] (Tg=70° C.); Poly(methyl methacrylate) [PMMA] (Tg=105° C.); Poly(vinyl chloride) [PVC] (Tg=80° C.); Polystyrene [PS] (Tg=95° C.); Polylactic acid [PLA] (Tg>60-65° C.); Polypropylene [PP] (Tg=0° C., Tm>130° C.); or Polycarbonate [PC] (Tg=145° C.). As noted above, these materials may be readily available for use as a gobo, but each has glass transition temperatures and/or melting temperature that may not permit there use in embodiments comprising light sources other than OLEDs, unless those light sources are, for instance, disposed at relatively large distances (e.g. greater than 5 cm apart) and/or heat management systems are utilized in the device.

In some embodiments, in the first device as described above comprising a first light source optically coupled to a gobo, the first device may further include a support structure. A “support structure” may refer to any device, component or apparatus that may be coupled to both the first light source and the gobo such that these components are disposed so as to be optically coupled. The support structure may comprise any number of components, including a power supply (or electrical connections to external power supplies) so as to provide current or voltage to the first light source. In some embodiments, the first light source and the gobo may be coupled to the support structure, where at least one of the first light source or the gobo is removably coupled to the support structure. The term “removably coupled” may refer to embodiments where the first light source or the gobo is not permanently coupled to the support structure (such that the removal of either would require altering the structure of the support structure). This may provide the ability in some embodiments to replace the first light source or the gobo, without replacing the whole first device (or a significant portion thereof).

In some embodiments, where the gobo is removably coupled to the support structure, the gobo may be adapted to be removed and recoupled to the support structure. In some instances, it may be desirable to be able to remove, replace or adjust the gobo, and then recouple it to the support element, or to remove the gobo entirely and place it on another support structure. In some embodiments, the support structure may comprise a conductive path to the first light source. As noted above, the support structure may supply power to the first light source, and the conductive path (which may comprise one or more conductors) may be embedded with the support structure so as to provide a path for the current or the voltage. In some embodiments, the support structure may be a light fixture. A “light fixture” may comprise any one of, or some combination of any of the following: a light source or lamp; a reflector; an aperture; a lens; a power supply; a connection to a power source; and/or a light socket to hold the lamp.

In some embodiments, in the first device as described above comprising a first light source optically coupled to a gobo, the first light source has an area that is greater than 10 cm².

The term “area” of the first light source may refer to the area of the surface of the substrate on which the organic light emitting devices are disposed over. In some embodiments, the first light source has an area that is greater than 25 cm². In some embodiments, the first light source has an area that is between approximately 20 cm² and 10 m². In some embodiments, the first light source may comprise multiple OLEDs disposed on one or more substrates. This may be especially applicable to embodiments where the first light source has an area that is between approximately 20 cm² and 10 m². For instance, it may be more economical (as far as manufacturing, installation, operation, etc.) in some instances to construct a large device (such as, for instance a large billboard) using multiple substrates having one or more OLEDs disposed thereon that are disposed adjacent to one another. In some instances, the substrates may be arranged so as to appear as a single substrate. As noted above, embodiments may have a wide range of applications, which may include small devices (such as for use as indicator lights or small aesthetic image displays) to large scale implementations (such as advertisements at bus stops or bill boards).

In some embodiments, in the first device as described above, the first device further comprises a light scattering layer disposed between the first light source and the gobo. The light scattering layer may, for instance, reduce the amount of light that may otherwise be reflected, blocked or otherwise trapped at an interface between two components. In some embodiments, in the first device as described above, the first light source comprises at least 50% luminance uniformity. As used herein, “luminance uniformity” may refer to the luminance of the first light source over the emissive regions. That is, the uniformity comprises a comparison of the luminance level over the portions of the first light source that emit light. As noted above, luminance may be measured at normal incidence to the substrate in the absence of a gobo. The inventors have recognized that, particularly for embodiments where the gobo may comprise an image, it may be preferred that the light emissions of the first light source be close to uniform such that there is no unwanted grayscaling or other optical effects provided by the first light source (that is, to the extent such effects are not intended). In some embodiments, the first light source comprises at least 80% luminance uniformity.

In some embodiments, in the first device as described above comprising a first light source optically coupled to a gobo, the first light source has a color uniformity (which may again be measured at normal incidence to the substrate) that has a duv value that is less than 0.010. The “color uniformity” may be a measure of the difference between the points on the 1971 CIE (L*, u*, v*) color space chromaticity diagram corresponding to the light emitted from any two portions of the emissive region of the first light source. For instance, in this context, having a duv that is less than 0.010 may indicate that there is no emissive region of the first light source that emits light that has a point on the 1971 CIE (L*, u*, v*) color space chromaticity diagram that is more than a distance of 0.010 away from a point corresponding to the light emission from any another emissive region of the first light source. In general, color uniformity may be desired in some embodiments, particularly when the first light source emits near white light, such that the first light source does not itself create unwanted optical effects (such as color tinting or other imperfections in an image or pattern provided by the gobo) that was not intended. The inventors have found that OLEDs may be more efficient in this regard for use in combination with a gobo because OLEDs typically emit more uniform color across the emissive area than other light sources.

In some embodiments, in the first device as described above comprising a first light source optically coupled to a gobo, the first light source includes only a single organic light emitting device. In some embodiments, in the first device as described above, the first light source comprises a plurality of organic light emitting devices. In some embodiments, in the first device as described above, the first light source comprises a plurality of organic light emitting devices disposed on a plurality of substrates. As was described herein, the first light source may comprise any number of OLEDs disposed on any number of substrates, and each OLED may comprise any number of different EL materials such that the first light source emits light having optical features desired for its application. In some embodiments, in the first device as described above, the first light source comprises a lighting panel.

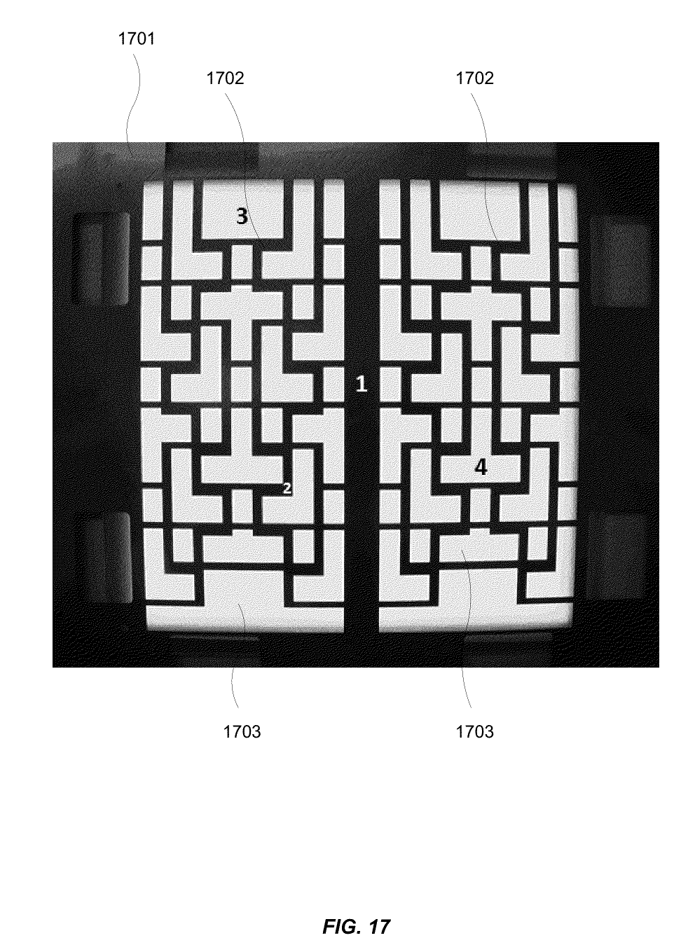

In some embodiments, in the first device as described above comprising a first light source optically coupled to a gobo, the gobo may comprise a stencil. As used herein, a “stencil” may refer to a gobo that comprises a first portion(s) that blocks substantially all light in the visible spectrum (i.e. light is not transmitted through those portions) and a second portion(s) that allows substantially all light in the visible spectrum (or light having a particular wavelength) to propagate through those portions. An example of a gobo comprising a stencil is shown in FIG. 4. Gobos that comprise a stencil may be used to create patterns of light emitted from the first device. In some instances, such devices may be designed to be indirect viewing devices (that is, the pattern may be designed to be displayed and viewed on a separate surface, rather than the pattern being viewed by directly looking at the first device). A stencil may, in some instances, comprise a three dimensional shape. In some embodiments, the gobo that comprises a stencil may comprise at least one of a plastic, glass or metal material. In some embodiments, the gobo that comprises a stencil may comprise an opaque material that is patterned. An example of such a device is shown in FIG. 17.

In some embodiments, in the first device as described above comprising a first light source optically coupled to a gobo, the gobo further includes a first portion having a first light transmission level, a second portion having a second transmission level, and a third portion having a third transmission level. The first, second, and third transmission levels may be different. The “transmission level” may refer to the amount of light having a particular wavelength or a particular composition of wavelengths that is transmitted through a region of the gobo. Thus, an embodiment that has a plurality of “transmission levels” may emit light having the same wavelength or composition of wavelengths at different brightness levels. Embodiments may thereby create a “grayscale” of an image, whereby the light transmitted through the different portions of the gobo appear brighter or darker, while potentially comprising light of the same wavelengths and thereby having the same chromaticity. The different transmission levels of the first device may be achieved in any suitable manner, such as by way of example, controlling the thickness and/or density of the gobo or any of the layers or materials of the gobo.

In some embodiments, the gobo may comprise one or more materials that act as color filters. Color filters may generally be divided into two different classes: (1) conventional color filters, and (2) dichroic color filters. Either class of color filter may be used to control transmission levels of the first device.

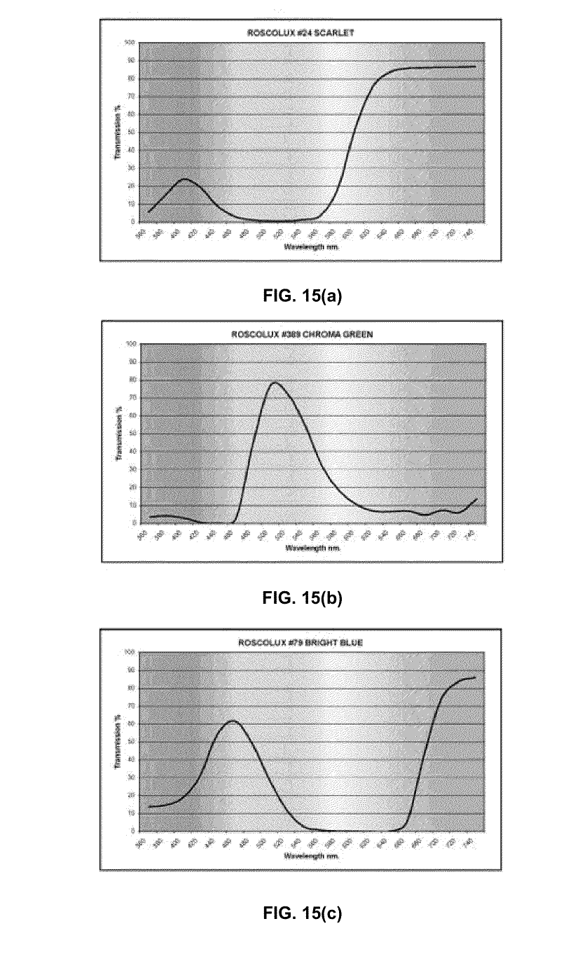

A conventional color filter comprises material that absorbs certain wavelengths of incident light. The remaining wavelengths pass through the color filter material, thus achieving the desired transmission level. Some examples of conventional color filter materials are gels, dyes, pigments and inks. Some examples transmission spectra for conventional color filters from the Rosco Roscolux range are shown in FIG. 15. In particular, FIG. 15(a) corresponds to an exemplary color filter for #24 Scarlet; FIG. 15(b) corresponds to an exemplary color filter for #389 Chroma Green; and FIG. 15(c) corresponds to an exemplary color filter for #79 Bright Blue.

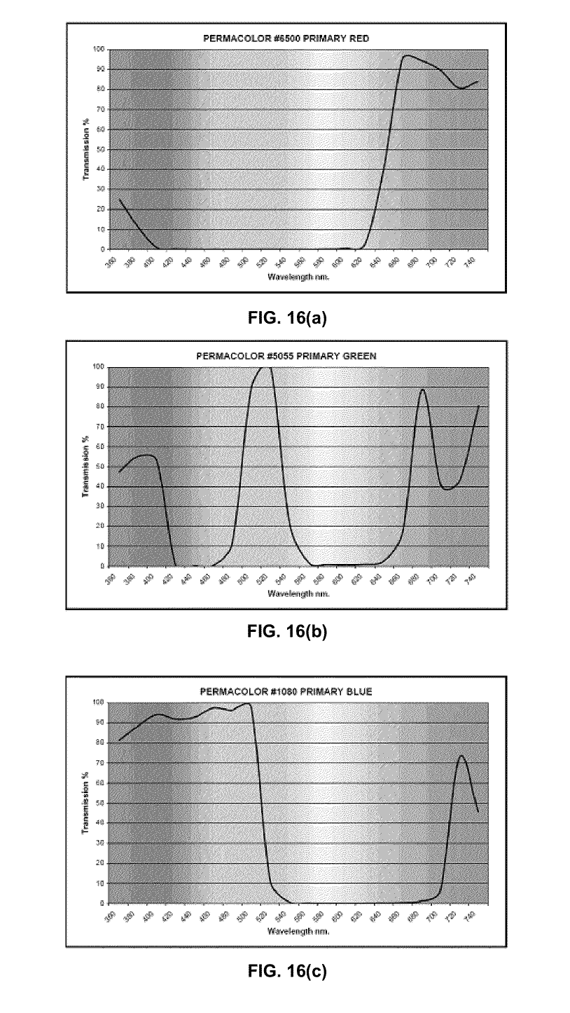

Instead of absorbing certain wavelengths of incident light, dichroic filters (also commonly called interference filters) reflect them, thus achieving the desired transmission level. In a dichroic mirror or filter, alternating layers with different refractive indexes are typically disposed on a glass substrate. The interfaces between layers of different refractive index produce phased reflections, selectively reinforcing certain wavelengths of light and interfering with other wavelengths. By controlling the thickness and number of layers, the range of wavelengths that are transmitted through the filter can be tuned and made as wide or narrow as desired. Because unwanted wavelengths are reflected rather than absorbed, dichroic filters do not absorb this unwanted energy during operation and so do not have as great of an increase in temperature as equivalent conventional color filters. However, initial fabrication costs may be high, owing to the typically large number of layers. Additionally, the effect of a dichroic filter is highly dependent on the angle at which light is incident upon the dichroic filter. Some examples of transmission spectra for dichroic color filters from the Rosco Permacolor range are shown in FIG. 16. That is, FIG. 16(a) corresponds to an exemplary color filter for #6500 Primary Red; FIG. 16(b) corresponds to an exemplary color filter for #5055 Primary Green; and FIG. 16(c) corresponds to an exemplary color filter for #1080 Primary Blue.

In some embodiments, the gobo may include at least two different color filters having different transmittance properties. In some embodiments, the gobo may include at least three different color filters having different transmittance properties.

In some embodiments, the gobo may comprise “dots” of color filter materials, and these dots may be located at varying distances from one another in different sections of the gobo. For example, in a first portion of the gobo the dots may be relatively close together (thereby creating small areas between the dots through which visible light may pass unimpeded); in a second portion of the gobo, the dots may be disposed relatively far apart from one another (thereby creating larger areas between the dots through which light may pass unimpeded); and in a third portion of the gobo, there may be no dots included (or spaced very far apart from one another), such that light may pass through this portion of the gobo relatively unimpeded. If the dots of color filter materials completely absorb incident light (e.g. black dots), or absorb light relatively uniformly across the entire visible spectrum, the result may be a grayscale image—that is, an image which has portions that appear brighter in some areas, and darker in others, but with substantially no change in chromaticity. If the dots of color filter materials allow transmission of selective wavelengths and inhibit the transmission of other wavelengths, the result may be an image with both brightness and color variation. In some embodiments, the dots of color filter materials may include dots of at least two different color filter materials having different transmittance properties. In some embodiments, the dots of color filter materials include at least three different color filter materials having different transmittance properties (e.g. red, green and blue dots). This kind of patterning of dots of color filter materials may readily be achieved by ink jet printing of inks, dyes, gels, pigments etc. by varying the size and location of droplets using a dithering process.

In some embodiments, rather than dots, there may be a continuous tonal variation across the gobo (i.e. the transmission level across the gobo may change continuously, thereby resulting in different transmission levels across the entire gobo). This kind of patterning may readily be achieved by, for instance, using dye-sublimation printing, which may result in true continuous tones appearing much like a chemical photograph. However, any suitable process may be used.

In some embodiments, in the first device as described above comprising a gobo optically coupled to a first light source, the gobo may include at least one down conversion material, which may absorb light having particular wavelengths and then remit light having different (and typically longer) wavelengths. That is, for instance, the first light source may emit light having a particular wavelength (or wavelengths), and the down conversion layer may absorb the emitted light or portions thereof (based on the absorption spectrum of the down conversion material) and remit light having a different (usually longer) wavelength (based on the emissive spectrum of the down conversion layer). In this way, light having different wavelengths may be transmitted (and/or emitted from) different portions of the gobo, and thereby render different images that may be perceived by an observer.

A first device may also be provided that comprises a first support structure configured to hold a first light source comprising one or more organic light emitting devices and a second support structure configured to hold a gobo. The first and second support structures may be manufactured separate from either the gobo and/or the first light source. The support structures may comprise any suitable material including a metal or plastic. In some embodiments, the first device may comprise a conductive path to the first light source, such that current or voltage may be supplied to the first light source. In this regard, in some embodiments, the first support structure (or the first device) may comprise a power source (or a location that may house a power source) or may comprise a component that may connect to a power source (such as a wire). In some embodiments, the first and the second support structures may be coupled together using any suitable means, including an adhesive or a fastener (such as a screw). In some embodiments, the first support structure and the second support structure are components of a single device (and may, for instance, be manufactured in the same process).

In some embodiments, in the first device as described above that includes a first and a second support structure, the first and/or the second support structure comprise a recess for receiving either the first light source or the gobo. The recess may be configured such that the first light source or the gobo may be screwed in, snapped in, inserted, or otherwise coupled to the first or second support structure by disposing the component into the recess. In some embodiments, in the first device as described above that includes a first and a second support structure, the second support structure is configured to hold a gobo that is removably coupled to the support structure. In this manner, embodiments may provide a support structure that may be used with multiple gobos, which may provide the benefit that a single device may be used to display multiple patterns or images (based on the use of different gobos).

In some embodiments, in the first device as described above that includes a first and a second support structure and where the first light source includes a light emitting zone, the first and second support structures are disposed such that a portion the light emitting zone of the first light source and the gobo are separated by less than approximately 1 cm. As noted above, the inventors have discovered that the typical characteristics of OLEDs may enable a device that has a configuration whereby the gobo and the first light source are in close proximity (in comparison to using other light sources). In some embodiments, the first and second support structures are disposed such that a portion of the light emitting zone of the first light source and the gobo are separated by less than approximately 1 mm. In some embodiments, the first and second support structures are disposed such that a portion of the light emitting zone of the first light source and the gobo are separated by less than approximately 0.5 mm.

A first method of creating an image may also be provided. The first method may comprise optically coupling a gobo to a first light source that includes one or more organic light emitting devices. The gobo and the first light source may be coupled in any suitable manner, and need not necessarily be coupled in a single apparatus. That is, the gobo and the first light source may be separate components that are disposed relative to one another such that the gobo is in the optical path of the light that is transmitted by the first light source. In some embodiments, the first method may further include the step of attaching the gobo to the first light source and/or coupling the first light source and the gobo to a single device structure.

Exemplary Device Fabrication

Provided below is a description of a experimental devices fabricated and tested by the inventors in accordance with some aspects as described above. This description is included for illustration purposes only and is not meant to be limiting.

To demonstrate exemplary embodiments of one or more devices that comprise a first OLED light source and a gobo such as those disclosed herein, the inventors fabricated a first exemplary 15 cm×15 cm white OLED light panel on a soda lime glass substrate having a thickness of 0.7 mm. The first exemplary OLED light panel design is shown in FIG. 7. As shown, the emissive area of the light panel was divided into 13,456 lighting elements (i.e. “pixels”), with each lighting element having dimensions 1.0 mm by 1.0 mm for an area of 1.0 mm². An enlarged view of the first exemplary lighting panel design is shown in FIG. 8, which better illustrates the individual lighting elements 801. The total emissive area of the first exemplary light panel comprising each of the lighting elements 801 was thereby 134.56 cm². The lighting elements 801 were separated by narrow gold bus lines 802 of width approximately equal to 80 μm. The narrow gold bus lines 802 were covered by an electrically insulating polyimide grid 803, which extended approximately 40 μm beyond the edge of the gold bus line 802 on either side. The gap between lighting elements 801 in this first exemplary panel was therefore approximately 160 μm. The first exemplary panel had an aperture ratio that was approximately equal to 77% within the outline of the lighting region. That is, 77% of the area within the emitting region of the first device emitted light (corresponding to each pixel), while 23% of the area did not emit light (corresponding to the bus line and insulting material). The non-emissive gap between lighting elements (i.e. the width of the bus line 802 and the extension of the insulating material 803) was relatively small, such that the first exemplary panel may appear to an observer to be a single uniform light source. In some embodiments, bus lines may not be used for the lighting panel, and the panel may instead comprise a single large area lighting element.

The OLED stack in the first exemplary lighting panel included, in order, an anode (1200 Å thick ITO), a hole injection layer (100 Å thick LG101, available from LG Chemicals of Korea), a hole transport layer (3800 Å thick NPD), a first emissive layer (200 Å thick Host B doped with 24% Green Dopant A and 0.8% Red Dopant A), a second emissive layer (75 Å thick Blue Host A doped with 22% Blue Dopant A), a blocking layer (50 Å thick Blue Host A), an electron transport layer (450 Å thick layer of LG201, available from LG Chemicals of Korea doped with 65% Liq), an electron injection layer (10 Å thick Liq), and a cathode (1000 Å thick Al). However, any suitable materials may be used for the layers to achieve a desired performance. In this first exemplary experimental panel, all emitters were phosphorescent emitters—which generally enable high efficiency devices with low operating current for a high light output. However, embodiments are not so limited and devices may, for instance, comprise fluorescent materials or a combination of phosphorescent and fluorescent materials.

A DR-70C diffusion filter commercially available from CLAREX® was optically connected to the first exemplary OLED light panel using index matching fluid having refractive index of n equal to 1.5. In some embodiments where a permanent connection is required, optical cement could be used instead of (or in addition to) index matching fluid. The thickness of the diffusion filter was 0.5 mm. The refractive index of the diffusion filter was 1.49. The refractive index of the diffusion filter approximately matched that of the soda lime glass substrate and the index matching fluid. The use of a diffusion filter with the lighting device may provide several benefits, including by way of example: (1) improving OLED light panel efficacy by improving light extraction [typically up to 50% higher efficiency can be achieved, as reported in Levermore et al., Phosphorescent OLEDs: Lighting the Way for Energy-Efficient Solid-State Light Sources, Inf. Disp. Vol. 26, No. 10, p. 18 (2010), which is hereby incorporated by reference in its entirety]; (2) minimizing color shift with viewing angle [typically Au'v′ may be less than 0.002 from 0-60°, as reported in Levermore et al., Phosphorescent OLEDs for High Efficiency Long Lifetime Solid State Lighting, SID Digest 2011 (72.2) p. 1060 which is hereby incorporated by reference in its entirety]; (3) redirecting light away from the surface normal to improve illumination off-angle for the device; and/or (4) improving localized luminance uniformity across the emissive area.

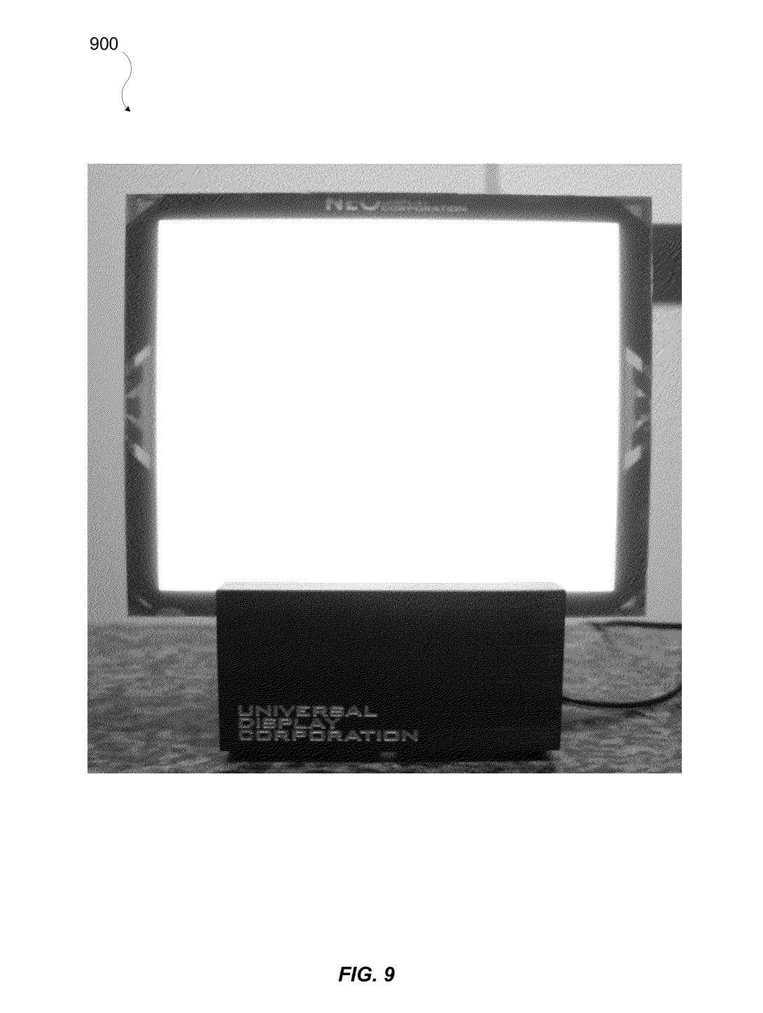

The latter effect of improving luminance uniformity across the emissive area arises because light from the lighting pixels can be averaged out with the non-emissive gaps in-between each pixel (e.g. the portions that may comprise a bus line) to produce a uniform sheet of light. This uniformity may be optimized by controlling the distance between the electroluminescent material (EML) and the diffuser filter (as described in UDC 68001 3D Light Extraction System with Uniform Emission Across, which is hereby incorporated by reference in its entirety). In general, greater uniformity may be achieved as this distance is increased. Luminance uniformity can also be improved by using a diffusion filter with lower parallel transmission, such that more photons are scattered. The parallel transmission of the filter used in this work with the first exemplary panel was Tₚₐᵣ=3%. For the first exemplary panel design shown in FIG. 7 and used in this experiment, with non-emissive gaps of approximately 160 μm between lighting elements having dimensions of 1.0 mm, it may be readily demonstrated that using a DR-70C diffusion filter of thickness 0.5 mm, commercially available from Clarex®, the device will comprise a substantially uniform sheet of light, as shown by the picture of the illuminated device 900 in FIG. 9.

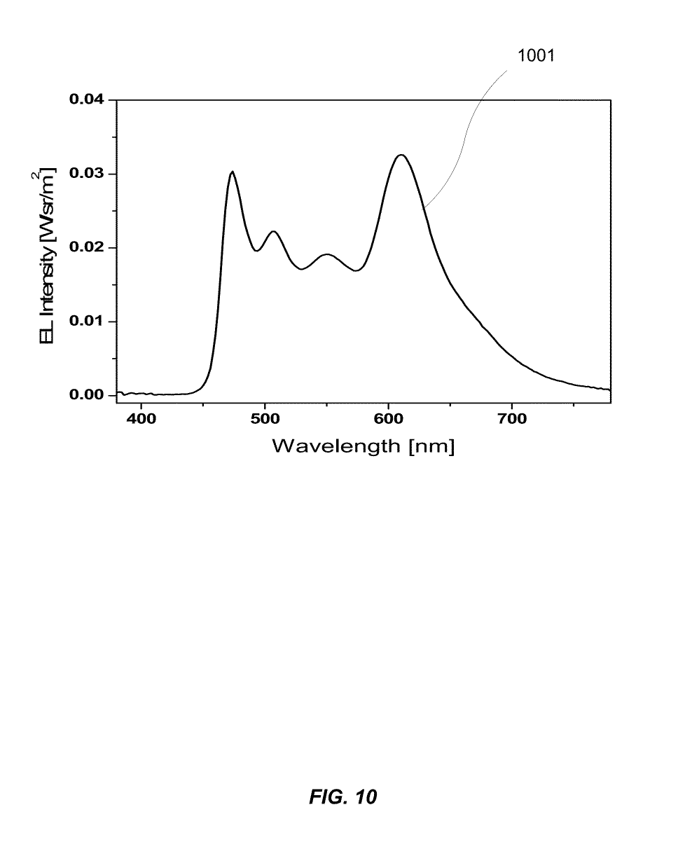

The electroluminescence (EL) spectrum of the first exemplary OLED light panel was measured at normal incidence using a PR-705 spectrophotometer. Drive current was set to I=500 mA (with current density of J=3.716 mA/cm² for each of the lighting elements). The measured EL spectrum 1001 is shown in FIG. 10. The first exemplary light panel used in this experiment emitted white light with CIE 1931 (x, y)=(0.405, 0.413), CRI=80, a correlated color temperature (CCT)=3680 K, and a Duv value equal to 0.010. Luminance was measured as approximately 1500 cd/m². It should be noted that the emission spectrum 1001 shown in FIG. 10 is very broad, with substantial emission across all wavelengths from 450 nm to 750 nm. That is, as shown, there are no gaps (corresponding to wavelengths of light) in the emission spectrum 1001 of the first exemplary OLED panel. In some embodiments, deeper blue and/or red emitters could be used to extend the range of the emission spectrum to even shorter and/or longer wavelengths.

As noted above, the CCT of the first exemplary light panel was measured to be equal to 3680 K, which is considered a warmish white. In some embodiments, the relative contribution of the different emitters could be altered to control the color temperature (i.e. to change the CCT of the light emitted by the device). For most commercial uses, it may be preferred that the color temperature would be in the range of 2700 to 9000 K. In particular, it may be preferred in some embodiments that the color temperature of the light emitted by the lighting panel would be in the range of 4000 to 6000 K. In addition, it may be preferred that the emitted light be near white, such that it has a Duv of less than 0.010. In some embodiments, it may be preferred that the emissions are very close to white light such that it has a Duv value of less than 0.005. In general, a lighting device that emits light that is near white may be more efficient (as there may be a better balance of each of the wavelengths used to generate the white light) and may render a larger variety of colors on a gobo optically coupled to the lighting device with greater fidelity (e.g., the image may not have any color tint associated with a light source not comprising near white light).

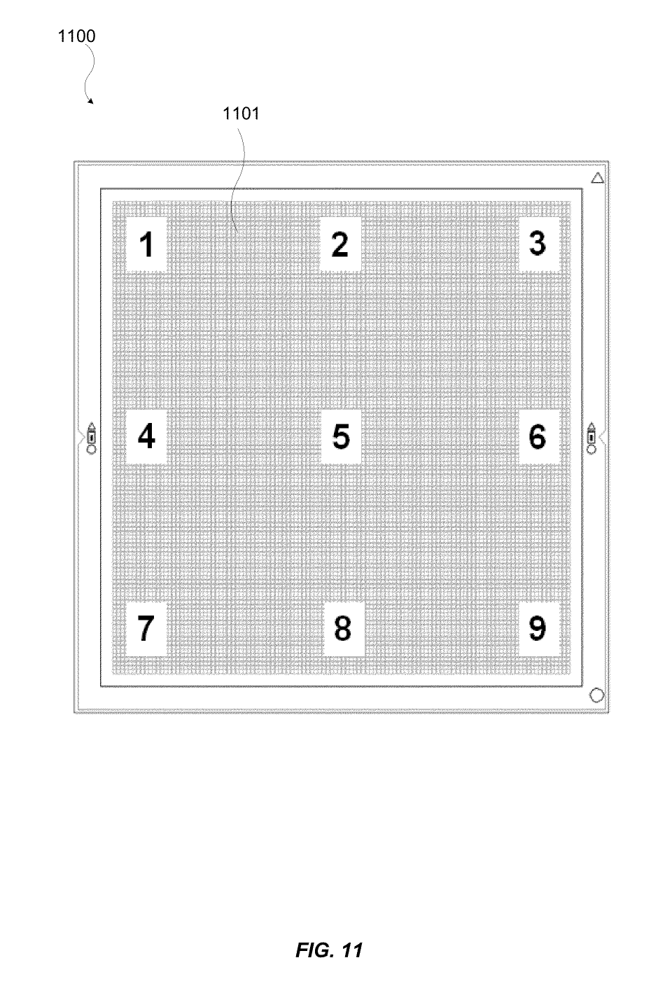

The luminance and emission color of the first exemplary light panel were measured at nine different positions on the panel using a Konica Minolta Chroma Meter CS-100A. These measurements were taken with the DR-70C diffusion filter optically connected to the panel using index matching fluid having refractive index n=1.5. The measurement locations are shown in FIG. 11 and numerically identified. The results are summarized in Table 1:

TABLE 1
Luminance and emission color measured at 9 positions
on the first exemplary 15 cm × 15 cm OLED light panel.

| Measurement Position | | |
|---|---|---|
| (indicated in FIG. 11) | Luminance [cd/m²] | CIE 1931 (x, y) |
| 1 | 1550 | (0.401, 0.402) |
| 2 | 1610 | (0.399, 0.404) |
| 3 | 1590 | (0.400, 0.403) |
| 4 | 1530 | (0.400, 0.404) |
| 5 | 1490 | (0.400, 0.404) |
| 6 | 1520 | (0.402, 0.402) |
| 7 | 1520 | (0.404, 0.401) |
| 8 | 1600 | (0.401, 0.405) |
| 9 | 1480 | (0.396, 0.406) |

Luminance uniformity (U) across the emissive region was determined to be U=(Lₘₐₓ−L_{min)/L}ₘₐₓ=92% (which was determined by finding the difference between the highest measured luminance and the lowest measured luminance level, and then dividing the difference by the highest luminance level). The color shift across the emissive region of the first exemplary panel was measured to be only duv=0.008. The CIE 1976 (L*, u*, v*) color space is used in preference over the CIE 1931 XYZ color space because in the CIE 1976 (L*, u*, v*) color space chromaticity diagram, distance is approximately proportional to perceived difference in color.

The conversion between coordinates in these color spaces is very simple: u′=4x/(−2x+l2y+3) and v′=9y/(−2x+l2y+3), where (x, y) are the coordinates of the CIE 1931 XYZ color space chromaticity diagram. From these results it can be seen that the exemplary lighting panel has excellent luminance and color uniformity across the emissive region.

Surface temperature was measured using a k-type thermocouple at 3 different positions on the panel (shown in FIG. 11 by positions 1, 5, and 9 on the emissive area 1101 of device 1100). Drive current was set to I=500 mA (with current density of J=3.716 mA/cm² for each of the lighting elements) and measurements were taken after 15 minutes of illumination in order to allow for panel surface temperature to stabilize. For these measurements, ambient temperature was 20.0° C. Measurements were taken under the following conditions: (1) surface of OLED panel; (2) surface of DR-70C diffuser sheet which is index-matched to OLED panel; (3) surface of gobo which is index-matched to OLED panel; and (4) surface of gobo which is index-matched to DR-70C diffuser sheet, which is itself index-matched to OLED panel. The surface temperature data is summarized in Table 2.

TABLE 2
Surface temperature at 3 positions on the 15
cm × 15 cm first exemplary OLED light panel.

| | Temperature | Temperature | Temperature | |
|---|---|---|---|---|
| | [C.] | [C.] | [C.] | Average |
| | Position 1 | Position 5 | Position 9 | Temperature |
| Device Details | (in FIG. 11) | (in FIG. 11) | (in FIG. 11) | [C.] |
| OLED Panel | 26.1 | 28.2 | 25.8 | 26.7 |
| OLED Panel + | 26.1 | 27.9 | 25.7 | 26.6 |
| DR-70C | | | | |
| OLED Panel + | 26.3 | 28.1 | 25.9 | 26.8 |
| Gobo | | | | |
| OLED Panel + | 25.8 | 27.8 | 25.7 | 26.4 |
| DR-70C + | | | | |
| Gobo | | | | |

Operating at J=3.716 mA/cm², panel operating temperature was less than 30° C. at all locations on the surface of the panel. Similar low temperatures are expected at the light emitting zone, as has been demonstrated in previous work such as, for instance, U.S. patent application Ser. No. 13/047,221 to Levermore et al. entitled “Method for Accelerated Lifetesting of Large Area OLED Lighting Panels,” which is hereby incorporated by reference in its entirety. Temperature is approximately 2° C. higher at the center of the panel than at the corners of the panel. This temperature gradient may arise because it is more straightforward to dissipate heat from the corners of the panel than from the center of the panel. The data also shows that in these embodiments, using a diffuser sheet and/or a gobo does not substantially reduce the surface temperature of the panel. The temperature at the surface of a gobo, which was index-matched to a DR70-C diffuser sheet, which was itself index-matched to the OLED panel, is only 0.3° C. lower than the surface temperature of the OLED panel. This demonstrates that neither the light scattering diffuser sheet nor gobo act as thermal management structures in this embodiment. It also demonstrates that the operating temperature of the gobo may be less than 30° C. under practical operating conditions.

In a first exemplary experimental embodiment, the first exemplary OLED light panel described above was used with a gobo (i.e. the lighting panel and a gobo were optically coupled). In this example, a low cost approach was taken to produce the gobo. In particular, a series of images were printed onto 3M Transparency Film (CG3410/20) using a HP Deskjet D2460 Color Inkjet Printer. However, embodiments are not so limited—for instance, the gobo could have been produced using a dye-sublimation printer or any other suitable device. One advantage of using a dye-sublimation printer may be that true continuous tones can be produced in a similar manner to a chemical photograph. Continuing with this first exemplary embodiment, different transparency films were then optically coupled to the first exemplary OLED light panel. In this first embodiment, the transparency films were not index-matched to the first exemplary OLED light panel; however, in some embodiments the transparency films could be index-matched to the first exemplary OLED light panel to increase performance and potentially light output.

FIGS. 12(a)-(d) illustrate two different exemplary gobos comprising transparency films. FIGS. 12(a) and 12(b) show the two exemplary transparency films placed in front of a blank sheet of white paper. FIGS. 12(c) and 12(d) show the same two transparency films placed in front of a sheet of white paper, where the word “TRANSPARENT” has been printed on the paper disposed behind the gobo. As can be seen in FIG. 12, the transparencies are in fact semi-transparent in that they permit some light to pass through some portions of the gobo, while blocking at least some of the light in other portions. In an exemplary embodiment, the transparencies shown in FIGS. 12(a) and/or 12(b) may be disposed relative to the first exemplary OLED light panel such that light emitted by the lighting panel passes through portions of the gobo (i.e. the lighting panel and the gobo may be optically coupled). In this way, the image of the gobo may be visible to a viewer, where the gobo is disposed between the viewer and the light source. The exemplary gobos shown in FIGS. 12(a) and (b) may permit some light emitted from one part of the first exemplary OLED light panel to be transmitted through the gobo, while blocking all (or a portion) of the light transmitted from a different part of the first exemplary OLED light panel. This may result in the illumination of an image or pattern, such as those shown in FIG. 12.

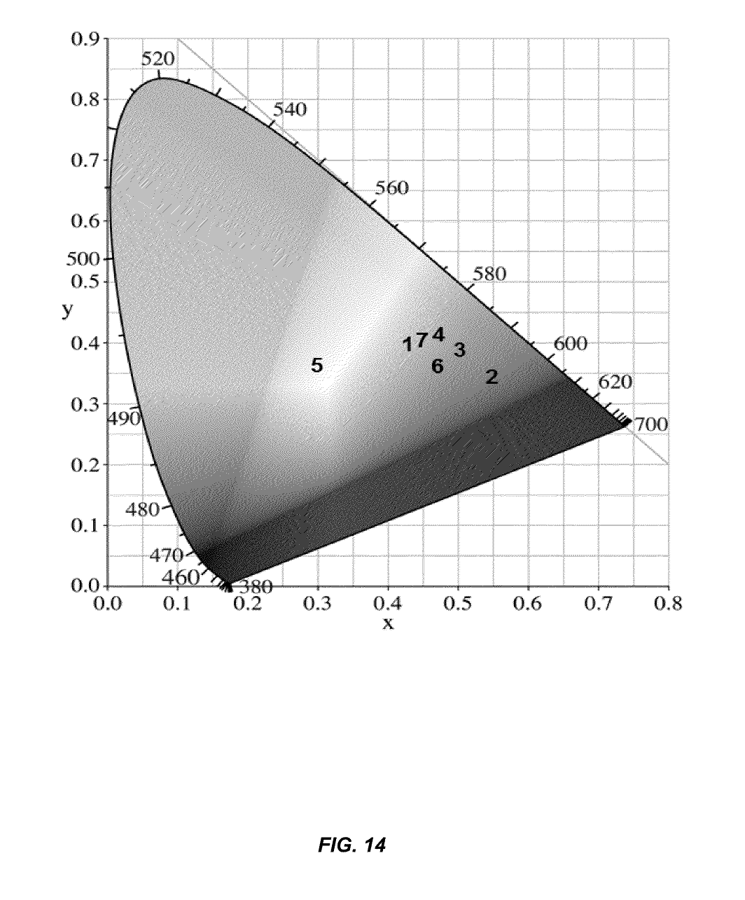

FIG. 13 shows the first exemplary OLED light panel described above with a third example gobo attached to the device (i.e. the lighting panel and the gobo are optically coupled). In this example the gobo is a color image printed on a transparency film. Light from the first exemplary OLED light panel passes through the transparency film, producing an illuminated image. As noted above, a full color image was printed on the transparency film and thereby because the first exemplary OLED light panel emits substantially white light, a full-color image is produced and may be visible to a viewer. For this experiment, the luminance and emission color were measured at various locations on the illuminated image shown in FIG. 13. Again, the exemplary device was driven by a current that was set to I=500 mA (and a current density for the pixels of J=3.716 mA/cm²). The positions where the measurements for this experiment were taken are shown by the numbers in FIG. 13. The measured data is summarized in Table 3, along with the approximate perceived color of the illuminated image. In addition, FIG. 14 shows where each of the measurement positions of the illuminated image fall on the 1931 CIE (x, y) diagram.

TABLE 3
Luminance and emission color at different locations
on the illuminated image in FIG. 13.

| Measurement | Approximate | Luminance | |
|---|---|---|---|
| Position | Color | [cd/m²] | CIE 1931 (x, y) |
| 1 | White | 1570 | (0.424, 0.402) |
| 2 | Red | 580 | (0.539, 0.348) |
| 3 | Orange | 920 | (0.496, 0.388) |
| 4 | Yellow | 1170 | (0.470, 0.409) |
| 5 | Cyan | 520 | (0.312, 0.368) |
| 6 | Violet | 640 | (0.472, 0.352) |
| 7 | White | 1050 | (0.444, 0.393) |

In the example embodiment shown in FIG. 13, a low-cost printing approach was used to fabricate the gobo. In some embodiments, commercially available color gels (such as those used in the photography, theatre and cinematography industries) could be patterned instead of, or in addition to, the low cost printing approach. The gels could be selected based on the desired color to be transmitted from that portion of the gobo. In this regard, the transmitted color defines the color of the image perceived by the viewer. In some embodiments, the color gels could be patterned, for instance, on transparent glass or plastic substrates. One advantage of utilizing an OLED lighting panel in such embodiments may be that the operating temperature of the OLED may be relatively low (particularly compared to the operating temperature of other lighting devices). The low operating temperature may enable the use of low-cost plastics as the substrate and/or the gobo (which materials are otherwise typically susceptible to heating and corresponding damage or deformation). As noted above, higher temperature light sources, such as incandescent bulbs or halogen lamps, may require glass substrates or expensive plastic substrates to withstand the additional heat generated.

In a second exemplary experimental embodiment, the first exemplary OLED light panel described above was used in combination with a gobo (i.e. the exemplary lighting panel and a gobo were optically coupled). In this second embodiment, a first stencil was used as the gobo. In particular, the exemplary stencil was fabricated by patterning holes into 200 micron thickness stainless steel foil. FIG. 17 shows the first stencil optically coupled to the first exemplary OLED light panel 1701. As shown, substantially all light in the visible spectrum is prevented from passing from the OLED light panel to an observer in the portions 1702 of the first stencil that comprise stainless steel foil. In contrast, as shown in FIG. 17, substantially all light in the visible spectrum may propagate from the light panel to the observer through the portions 1703 of the first stencil where the stainless steel foil has been removed (i.e. where there are now “holes” in the first stencil). In this second exemplary embodiment, the holes 1703 are polygon apertures with dimensions on the order of centimeters. In general, each of the holes 1703 in the first stencil may be clearly visible to an observer at a typical viewing distance (i.e. at a distance of approximately 10 cm or greater from the device).

The inventors measured the luminance of this exemplary device at normal incidence to the device at the locations shown in FIG. 17 using a Konica Minolta Chroma Meter CS-100A. For these measurements the panel was operated at I=500 mA (J=3.716 mA/cm²). Luminance was measured at four different locations on the first exemplary OLED light panel, as shown by the numbers in FIG. 17. At the locations designated 1 and 2 in FIG. 17, the measured luminance was approximately 20 cd/m², which confirms that at these locations, the stencil substantially prevents all light in the visible spectrum from propagating from the first OLED light panel to an observer. It is likely that this very low luminance arises as a result of scattered light, rather than light propagating through the stencil. At the locations designated 3 and 4 in FIG. 17, the measured luminance was 1580 cd/m² and 1600 cd/m², respectively, which shows that at these locations, the stencil substantially allows all light in the visible spectrum to propagate from the OLED light panel to an observer. These measurements were consistent with the values shown in Table 1 for the exemplary first light panel 1701.

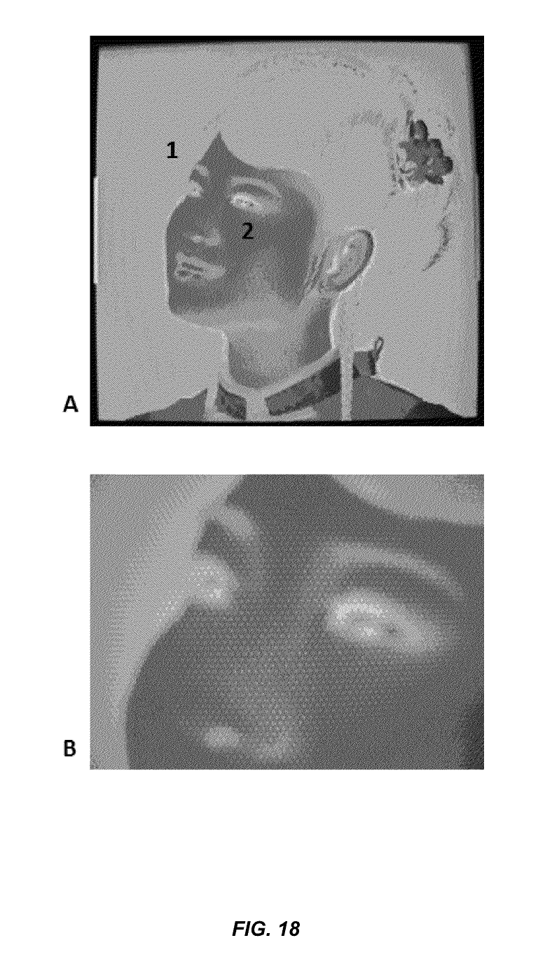

In a third exemplary experimental embodiment, the inventors used the first exemplary OLED light panel described above with a gobo (i.e. the lighting panel and a gobo were optically coupled). In this third embodiment, a second stencil was used as the gobo. In particular, the second stencil was fabricated by patterning holes into 200 micron thickness stainless steel foil. FIG. 18(a) shows the second stencil optically coupled to the first exemplary OLED light panel. As shown, substantially all light in the visible spectrum is prevented from passing from the OLED light panel to an observer in the portions of the stencil where there is stainless steel foil. In contrast, substantially all light in the visible spectrum may propagate from the light panel to the observer in the portions of the stencil where the stainless steel foil has been removed (i.e. where there are now “holes” in the second stencil). In this third exemplary embodiment, the holes are hexagonal apertures with dimensions on the order of hundreds of microns. The individual holes may not be distinguished at typical viewing distances (i.e. at a distance further than approximately 10 cm from the device). The size and density of the holes may be used to control the localized brightness from the device. Luminance was measured at normal incidence to the device shown in FIG. 18(a) using a Konica Minolta Chroma Meter CS-100A. For these measurements the panel was operated at I=500 mA (J=3.716 mA/cm²). Luminance was measured at two different locations, as shown by the numbers in FIG. 18(a). At the location designated 1, luminance was measured to be 727 cd/m², while at the location designated 2, luminance was measured to be 305 cd/m². The higher luminance at location 1 in comparison to at location 2 (in FIG. 18(a)) my be because the holes are larger and/or disposed in closer proximity to adjacent holes at location 1 relative to at location 2. This is shown in the close-up if the device shown in FIG. 18(b), where the lighter dots correspond to portions of the gobo where visible light propagates through holes in the second stencil. Darker areas surrounding the dots correspond to portions where the stainless steel foil blocks visible light from passing from the OLED light panel to an observer.

In a fourth exemplary experimental embodiment, a second exemplary OLED light panel was used in combination with a gobo (i.e. the second lighting panel and a gobo were optically coupled). In this fourth embodiment, the second exemplary OLED light panel was fabricated on a 60 micron thickness flexible stainless steel foil substrate. The stainless steel foil was coated with a 6 micron thickness layer of polyimide. The OLED device stack was then deposited onto the polyimide layer. The OLED stack in the second exemplary OLED light panel included, in order, an anode (2000 Å thick IZO), a hole injection layer (100 Å thick LG101, available from LG Chemicals of Korea), a hole transport layer (2800 Å thick NPD), a first emissive layer (200 Å thick Host B doped with 24% Green Dopant A and 0.8% Red Dopant A), a second emissive layer (75 Å thick Blue Host A doped with 22% Blue Dopant A), a blocking layer (50 Å thick Blue Host A), an electron transport layer (450 Å thick layer of LG201, available from LG Chemicals of Korea doped with 65% Liq), an electron injection layer (10 Å thick Liq), a cathode (120 Å thick Mg:Ag 10%), and a capping layer (600 Å thick NPD). However, embodiments are not limited to the examples provided herein, and any suitable materials and thicknesses may be used for the layers to achieve a desired performance. In this exemplary experimental device, all emitters were phosphorescent emitters, which generally enable high efficiency devices with low operating current for high light output. However, embodiments are not so limited and devices may, for instance, comprise fluorescent materials or a combination of phosphorescent and fluorescent materials. The second exemplary OLED light panel was encapsulated with a 6 micron thickness thin film encapsulation (TFE) layer and an additional hardcoat layer. The secondary exemplary OLED light panel is shown in FIGS. 19(a)-(d). Light emission is from a 23.6 cm² circular emissive area.

In this fourth exemplary embodiment the flexible second exemplary OLED light panel was optically coupled to a flexible gobo. A low cost approach was taken to produce the gobo. In particular, a grayscale image was printed onto a flexible 3M Transparency Film (CG3410/20) using a HP Deskjet D2460 Color Inkjet Printer. FIG. 19(a) shows the flexible second exemplary OLED light panel 1901 in a planar (unflexed) configuration (i.e. a first position). FIG. 19(b) shows the same panel 1901 in a flexed configuration (i.e. a second position). FIG. 19(c) shows the flexible second exemplary OLED light panel 1901 in a planar (unflexed) configuration, where the flexible panel is optically coupled to a flexible gobo 1902. As shown, the flexible gobo 1902 (which is in image of a woman) conforms to the flexible substrate 1901 in this configuration. The gobo may be coupled to the gobo in any suitable way, but as shown, in this exemplary embodiments, a weakly binding adhesive was used, such that the gobo could be removably coupled to the flexible substrate. That is, an adhesive was directly applied to the gobo and a surface of the first light source. FIG. 19(d) shows the flexible second exemplary OLED light panel 1901 in a flexed configuration, where the flexible panel 1901 is optically coupled to the flexible gobo 1902. The flexible gobo 1902 conforms to the flexible substrate in this second position. That is, the flexible gobo 1902 in this exemplary embodiment conforms to the exemplary OLED light panel in both the flexed and unflexed position. Differential transmission of light allowed by the flexible gobo 1902 is clearly shown in FIGS. 19(c) and (d), where an illuminated image is formed and can be perceived by a viewer.

Although not specifically demonstrated in the exemplary experimental embodiments described above, in some embodiments, a gobo may be used with a high intensity light source to project an image onto another surface (e.g. the “Bat Lamp”). The first light source in such embodiments may comprise an OLED panel if the luminance of the device is set relatively high. In addition, in some embodiments, additional optics (such as lenses, etc.) may be used to either focus or enlarge the image. However, as noted above and shown in the exemplary experimental embodiment, if the luminance of an OLED panel optically coupled to a gobo is relatively low, the illuminated image could also be viewed directly by the viewer.

Although not specifically demonstrated in exemplary experimental embodiments, the OLED panel could be dimmable such that the luminance of the device may be varied (i.e. by varying the current or voltage supplied). The OLED panel could also be color tunable (as demonstrated by Verbatim Lighting with their color tunable Velve OLED panels. See Verbatim launches world's first commercially available, colour tunable OLED lighting [online], from Verbatim Lighting [retrieved on 2011/09/19], retrieved from the Internet: <URL: http://www.verbatimlighting.eu/en 1/led-newsroom-verbatim-launches-worlds-first-commercially-available-colour-tunable-oled-lighting_{—}4313.html>, which is hereby incorporated by reference in its entirety. In some embodiments, by tuning the emission color of the panel, the color of the illuminated image may be controlled. In some embodiments, it may be preferred that a printed grayscale image be used as a gobo that is optically coupled to a color tunable OLED panel.

It is understood that the various embodiments described herein are by way of example only, and are not intended to limit the scope of the invention. For example, many of the materials and structures described herein may be substituted with other materials and structures without deviating from the spirit of the invention. The present invention as claimed may therefore include variations from the particular examples and preferred embodiments described herein, as will be apparent to one of skill in the art. It is understood that various theories as to why the invention works are not intended to be limiting.

A recitation of “a”, “an” or “the” is intended to mean “one or more” unless specifically indicated to the contrary.

What is claimed is:

1. A first device comprising:
a first light source comprising one or more organic light emitting devices; and
a gobo that is optically coupled to the first light source;
wherein the gobo allows differential transmission of light emitted by different parts of the first light source to create a fixed variation in the light emitted by the first device.

2. The first device of claim 1, wherein the first light source comprises a plurality of organic light emitting devices that are commonly addressable.

3. The first device of claim 1,
wherein the first light source emits white light with Duv that is less than 0.010.

4. The first device of claim 3, wherein the first light source is color tunable between a correlated color temperature (CCT) of approximately 3500 K to 6500 K.

5. The first device of claim 1, wherein the first light source is dimmable.

6. The first device of claim 1,
wherein the first light source comprises a light emitting zone; and
wherein a first distance between a portion of the light emitting zone of the first light source and a portion of the gobo is less than 1 cm.

7. The first device of claim 6, wherein the maximum distance between a portion of the light emitting zone of the first light source and a portion of the gobo is less than 1 cm.

8. The first device of claim 1, wherein a surface of the first light source and the gobo are in physical contact.

9. The first device of claim 8, wherein a surface of the first light source and the gobo are in physical contact across the entire emissive area of the first light source.

10. The first device of claim 1, wherein the first device does not comprise a cooling element disposed between the first light source and the gobo.

11. The first device of claim 1, wherein the gobo is disposed relative to the first light source such that the temperature of the gobo does not exceed 50° C. when the first device is in operation.

12. The first device of claim 6, wherein the gobo is disposed relative to the first light source such that there is no part of the gobo that has a temperature that is more than 50° C. greater than ambient temperature when the first device is in operation.

13. The first device of claim 6, wherein the gobo is disposed relative to the first light source such that there is no part of the gobo that has a temperature that is more than 30° C. greater than ambient temperature when the first device is in operation.

14. The first device of claim 1,
wherein the first light source comprises a substrate; and
wherein each of the organic light emitting devices of the first light source comprises:
a first electrode disposed over the substrate;
a second electrode disposed over the first electrode; and
an organic electroluminescent (EL) material disposed between the first and the second electrode.

15. The first device of claim 14, wherein the substrate is rigid.

16. The first device of claim 15,
wherein the gobo is flexible;
wherein the first light source comprises an emissive area; and
wherein the gobo is configured to be selectively optically coupled to at least a portion of the emissive area of the first light source.

17. The first device of claim 14, wherein the substrate and the gobo are flexible.

18. The first device of claim 17, wherein at least a portion of the gobo substantially conforms to at least a portion of the substrate.

19. The first device of claim 1, wherein the gobo is removably coupled to the first light source using an adhesive.

20. The first device of claim 1, wherein the gobo and the first light source have a combined thickness that is less than approximately 5 cm.

21. The first device of claim 1, wherein the gobo and the first light source have a combined thickness that is less than approximately 1 mm.

22. The first device of claim 12, wherein the first light source has a luminance of at least 1000 cd/m².

23. The first device of claim 12, wherein the first light source has a luminance of at least 5000 cd/m².

24. The first device of claim 1, wherein the gobo comprises a material that is not stable at temperatures that are greater than 150° C.

25. The first device of claim 1, wherein the gobo comprises a material that is not stable at temperatures that are greater than 100° C.

26. The first device of claim 1, wherein the gobo comprises a transparent or translucent plastic.

27. The first device of claim 1, wherein the first light source has an area that is between approximately 20 cm² and 10 m².

28. The first device of claim 27, wherein the first light source comprises a plurality of substrates.

29. The first device of claim 1, further comprising a light scattering layer disposed between the first light source and the gobo.

30. The first device of claim 1, wherein the first light source comprises at least 50% luminance uniformity.

31. The first device of claim 1, wherein the first light source comprises a single organic light emitting device.

32. The first device of claim 1, wherein the gobo comprises a stencil.

33. The first device of claim 1, wherein the gobo comprises a color filter.

34. The first device of claim 33, wherein the gobo is a sheet of plastic having an image rendered thereon by one or more gels that preferentially transmit a portion of the visible spectrum.

35. The first device of claim 1, wherein the gobo includes at least one down conversion material.

36. A first device comprising:
a first support structure configured to hold a first light source comprising one or more organic light emitting devices; and
a second support structure configured to hold a gobo.

37. The first device of claim 36, wherein the second support structure is configured to hold a gobo that is removably coupled to the support structure.

38. A first method of creating an image comprising:
optically coupling a gobo to a first light source that comprises one or more organic light emitting devices.

39. The first method of claim 38, further comprising the step of attaching the gobo to the first light source.
